(19) United States
(12) Patent Application Publication
(10) Pub. No.: US 2023/0415343 A1
(43) Pub. Date: Dec. 28, 2023

(54) AUTOMATICALLY TRASITIONING A ROBOT TO AN OPERATIONAL MODE OPTIMIZED FOR PARTICULAR TERRAIN

(71) Applicant: Boston Dynamics, Inc., Waltham, MA (US)

(72) Inventor: Eric Whitman, Arlington, MA (US)

(73) Assignee: Boston Dynamics, Inc., Waltham, MA (US)

(21) Appl. No.: 18/336,385

(22) Filed: Jun. 16, 2023

Related U.S. Application Data
(60) Provisional application No. 63/354,854, filed on Jun. 23, 2022.

(51) Int. Cl. B25J 9/16; B62D 57/024; B62D 57/032

(52) U.S. Cl. CPC B25J 9/1664; B62D 57/024; B62D 57/032; B25J 9/1697

(57) ABSTRACT

According to one disclosed method, one or more sensors of a robot may receive data corresponding to one or more locations of the robot along a path the robot is following within an environment on a first occasion. Based on the received data, a determination may be made that one or more stairs exist in a first region of the environment. Further, when the robot is at a position along the path the robot is following on the first occasion, a determination may be made that the robot is expected to enter the first region. The robot may be controlled to operate in a first operational mode associated with traversal of stairs when it is determined that one or more stairs exist in the first region and the robot is expected to enter the first region.

### RELATED APPLICATIONS

This application claims the benefit under 35 U.S.C. § 119(e) of U.S. Provisional Patent Application Ser. No. 63/354,854, filed Jun. 23, 2022, and entitled, “AUTOMATICALLY TRASITIONING A ROBOT TO AN OPERATIONAL MODE OPTIMIZED FOR PARTICULAR TERRAIN,” the entire contents of which is incorporated herein by reference.

### BACKGROUND

A robot is generally a reprogrammable and multifunctional manipulator, often designed to move material, parts, tools, or specialized devices through variable programmed motions for performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

In some embodiments of the present disclosure, a mobile robot includes a robot body, one or more locomotion based structures, coupled to the body, configured to move the mobile robot about an environment, one or more sensors, supported by the body, configured to output data concerning one or more sensed conditions of the environment, at least one processor, and at least one computer-readable medium encoded with instructions which, when executed by the at least one processor, cause the mobile robot to receive, by the one or more sensors, data corresponding to one or more locations of the mobile robot along a path the mobile robot is following within the environment on a first occasion, to determine, based on the data, that one or more stairs exist in a first region of the environment, to determine, when the mobile robot is at a position along the path the mobile robot is following on the first occasion, that the mobile robot is expected to enter the first region, and to control the mobile robot to operate in a first operational mode associated with traversal of stairs when it is determined that one or more stairs exist in the first region and the mobile robot is expected to enter the first region.

In some embodiments, a mobile robot includes a robot body, one or more locomotion based structures, coupled to the body, configured to move the mobile robot about an environment, one or more sensors, supported by the body, configured to output data concerning one or more sensed conditions of the environment, at least one processor, and at least one computer-readable medium encoded with instructions which, when executed by the at least one processor, cause the mobile robot to determine, based on data received from the one or more sensors of a robot operating within the environment, that one or more stairs exist in a first region of the environment, to determine, while an operator is guiding movement of the mobile robot about the environment, that the mobile robot is expected to enter the first region, and to control the mobile robot to operate in a first operational mode associated with traversal of stairs when it is determined that one or more stairs exist in the first region and the mobile robot is expected to enter the first region.

In some embodiments, a mobile robot includes a robot body, one or more locomotion based structures, coupled to the body, configured to move the mobile robot about an environment, one or more sensors, supported by the body, configured to output data concerning one or more sensed conditions of the environment, at least one processor, and at least one computer-readable medium encoded with instructions which, when executed by the at least one processor, cause the mobile robot to receive, by the one or more sensors of a robot, data corresponding to one or more locations of the mobile robot along a path the mobile robot is following within the environment on a first occasion, to determine, based on the data, that a first condition exists for terrain in a first region of the environment, to determine, when the mobile robot is at a position along the path the mobile robot is following on the first occasion, that the mobile robot is expected to enter the first region, and to control the mobile robot to operate in a first operational mode associated with the first condition when it is determined that the first condition exists for terrain in the first region and the mobile robot is expected to enter the first region.

In some embodiments, a mobile robot includes a robot body, one or more locomotion based structures, coupled to the body, configured to move the mobile robot about an environment, one or more sensors, supported by the body, configured to output data concerning one or more sensed conditions of the environment, at least one processor, and at least one computer-readable medium encoded with instructions which, when executed by the at least one processor, cause the mobile robot to determine, based on data received from the one or more sensors of a robot operating within the environment, that a first condition exists for terrain in a first region of the environment, to determine, while an operator is guiding movement of the mobile robot about the environment, that the mobile robot is expected to enter the first region, and to control the mobile robot to operate in a first operational mode associated with traversal of terrain for which the first condition exists when it is determined that the first condition exists for terrain in the first region and the mobile robot is expected to enter the first region.

In some embodiments, a method involves receiving, by one or more sensors of a robot, data corresponding to one or more locations of the robot along a path the robot is following within an environment on a first occasion; determining, based on the data, that one or more stairs exist in a first region of the environment; determining, when the robot is at a position along the path the robot is following on the first occasion, that the robot is expected to enter the first region; and controlling the robot to operate in a first operational mode associated with traversal of stairs when it is determined that one or more stairs exist in the first region and the robot is expected to enter the first region.

In some embodiments, a method involves determining, based on data received from one or more sensors of a robot operating within an environment, that one or more stairs exist in a first region of the environment; while an operator is guiding movement of the robot about the environment, determining that the robot is expected to enter the first region; and controlling the robot to operate in a first operational mode associated with traversal of stairs when it is determined that one or more stairs exist in the first region and the robot is expected to enter the first region.

In some embodiments, a method involves receiving, by one or more sensors of a robot, data corresponding to one or more locations of the robot along a path the robot is following within an environment on a first occasion; determining, based on the data, that a first condition exists for terrain in a first region of the environment; determining, when the robot is at a position along the path the robot is following on the first occasion, that the robot is expected to enter the first region; and controlling the robot to operate in a first operational mode associated with the first condition when it is determined that the first condition exists for terrain in the first region and the robot is expected to enter the first region.

In some embodiments, a method involves determining, based on data received from one or more sensors of a robot operating within an environment, that a first condition exists for terrain in a first region of the environment; while an operator is guiding movement of the robot about the environment, determining that the robot is expected to enter the first region; and controlling the robot to operate in a first operational mode associated with traversal of terrain for which the first condition exists when it is determined that the first condition exists for terrain in the first region and the robot is expected to enter the first region.

In some embodiments, a system includes at least one processor, and at least one computer-readable medium encoded with instructions which, when executed by the at least one processor, cause the system to receive, by one or more sensors of a robot, data corresponding to one or more locations of the robot along a path the robot is following within an environment on a first occasion, to determine, based on the data, that one or more stairs exist in a first region of the environment, to determine, when the robot is at a position along the path the robot is following on the first occasion, that the robot is expected to enter the first region, and to control the robot to operate in a first operational mode associated with traversal of stairs when it is determined that one or more stairs exist in the first region and the robot is expected to enter the first region.

In some embodiments, a system includes at least one processor, and at least one computer-readable medium encoded with instructions which, when executed by the at least one processor, cause the system to determine, based on data received from one or more sensors of a robot operating within an environment, that one or more stairs exist in a first region of the environment, to determine, while an operator is guiding movement of the robot about the environment, that the robot is expected to enter the first region, and to control the robot to operate in a first operational mode associated with traversal of stairs when it is determined that one or more stairs exist in the first region and the robot is expected to enter the first region.

In some embodiments, a system includes at least one processor, and at least one computer-readable medium encoded with instructions which, when executed by the at least one processor, cause the system to receive, by one or more sensors of a robot, data corresponding to one or more locations of the robot along a path the robot is following within an environment on a first occasion, to determine, based on the data, that a first condition exists for terrain in a first region of the environment, to determine, when the robot is at a position along the path the robot is following on the first occasion, that the robot is expected to enter the first region, and to control the robot to operate in a first operational mode associated with the first condition when it is determined that the first condition exists for terrain in the first region and the robot is expected to enter the first region.

In some embodiments, a system includes at least one processor, and at least one computer-readable medium encoded with instructions which, when executed by the at least one processor, cause the system to determine, based on data received from one or more sensors of a robot operating within an environment, that a first condition exists for terrain in a first region of the environment, to determine, while an operator is guiding movement of the robot about the environment, that the robot is expected to enter the first region, and to control the robot to operate in a first operational mode associated with traversal of terrain for which the first condition exists when it is determined that the first condition exists for terrain in the first region and the robot is expected to enter the first region.

In some embodiments, at least one non-transitory, computer-readable medium is encoded with instructions which, when executed by at least one processor of a system, cause the system to receive, by one or more sensors of a robot, data corresponding to one or more locations of the robot along a path the robot is following within an environment on a first occasion, to determine, based on the data, that one or more stairs exist in a first region of the environment, to determine, when the robot is at a position along the path the robot is following on the first occasion, that the robot is expected to enter the first region, and to control the robot to operate in a first operational mode associated with traversal of stairs when it is determined that one or more stairs exist in the first region and the robot is expected to enter the first region.

In some embodiments, at least one non-transitory, computer-readable medium is encoded with instructions which, when executed by at least one processor of a system, cause the system to determine, based on data received from one or more sensors of a robot operating within an environment, that one or more stairs exist in a first region of the environment, to determine, while an operator is guiding movement of the robot about the environment, that the robot is expected to enter the first region, and to control the robot to operate in a first operational mode associated with traversal of stairs when it is determined that one or more stairs exist in the first region and the robot is expected to enter the first region.

In some embodiments, at least one non-transitory, computer-readable medium is encoded with instructions which, when executed by at least one processor of a system, cause the system to receive, by one or more sensors of a robot, data corresponding to one or more locations of the robot along a path the robot is following within an environment on a first occasion, to determine, based on the data, that a first condition exists for terrain in a first region of the environment, to determine, when the robot is at a position along the path the robot is following on the first occasion, that the robot is expected to enter the first region, and to control the robot to operate in a first operational mode associated with the first condition when it is determined that the first condition exists for terrain in the first region and the robot is expected to enter the first region.

In some embodiments, at least one non-transitory, computer-readable medium is encoded with instructions which, when executed by at least one processor of a system, cause the system to determine, based on data received from one or more sensors of a robot operating within an environment, that a first condition exists for terrain in a first region of the environment, to determine, while an operator is guiding movement of the robot about the environment, that the robot is expected to enter the first region, and to control the robot to operate in a first operational mode associated with traversal of terrain for which the first condition exists when it is determined that the first condition exists for terrain in the first region and the robot is expected to enter the first region.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1A is a perspective view of an example robot standing atop a landing of a staircase;

FIG. 1B is a schematic view of example systems of a robot, such as the robot of FIG. 1A;

FIGS. 2A and 2B are schematic views of example stair trackers for a robot, such as the robot of FIG. 1A;

FIG. 3 is a block diagram including an example stairs mode setting selector and associated components of a robot, such as the robot of FIG. 1A;

FIG. 4 is an example decision tree that may be executed by a stairs mode setting selector, such as the stairs mode setting selector shown in FIG. 3;

FIG. 5 is a table showing examples of setting values that a stairs mode setting selector, such as the stairs mode setting selector shown in FIG. 3, may apply to a robot, such as the robot of FIG. 1A, based on execution of a decision tree, such as the decision tree shown in FIG. 4; and

FIG. 6 illustrates an example configuration of a robotic device, according to some embodiments.

### DETAILED DESCRIPTION

Various techniques that can be employed by robots to travel within environments that include stairs, among other features, are described in prior-filed patent applications by the Assignee of the present disclosure, including U.S. Patent Application Publication No. 2021/0323618 (“the '618 Publication”), U.S. Patent Application Publication No. 2021/0333804 (“the '804 Publication) and U.S. Pat. No. 11,123,869 (“the '869 Patent”), the entire contents of each of which are incorporated herein by reference. As those applications describe, a robot may be configured so that it can be selectively put in an operational mode designed specifically to perceive and traverse stairs. That operational mode is referred to herein as “stairs mode.” Examples of particular settings for the robot that can (A) facilitate the perception of nuances of stairs, and (B) optimally control aspects of the robot to successfully traverse stairs, are described in the '804 Publication and the '869 Patent, and are also described in additional detail below.

The '618 Publication further describes how a robot may undergo an initial mapping process during which the robot may move about an environment (typically in response to commands input by a user to a tablet or other controller) to gather data (e.g., via one or more sensors) about the environment and may generate a topological map that defines “waypoints” of the robot as well as “edges” representing paths between respective pairs of such waypoints. Individual waypoints may, for example, represent sensor data, fiducials, and/or robot pose information at specific times and locations, whereas individual edges may connect waypoints topologically and define the local transform between the reference frames of the interconnected waypoints. When the robot detects stairs during such an initial mapping process, it may annotate the map accordingly to identify the region(s) in which the stairs were detected. After such a topological map has been generated, the robot may autonomously traverse a path including the waypoints identified on the map and, based on the annotations in the map that indicate the regions at which stairs were detected, may automatically enter the “stairs mode” before entering the indicated regions.

The inventor of the present disclosure has recognized and appreciated that the foregoing approaches may be improved. For instance, in the absence of a previously generated map that identifies stair locations, the robot may not enter the “stairs mode” unless the operator of the robot explicitly instructs the robot to do so. For example, after using a joystick or the like on a controller to steer the robot to the bottom or top of a staircase, the operator may be required to hit a button or other element on the controller to transition the robot from its current operational mode and corresponding gait (e.g., “walk,” “crawl,” “jog,” etc.) to the “stairs mode” before again moving the joystick to steer the robot to begin traversing, e.g., ascending or descending, the staircase. Imposing such a requirement (i.e., to manually transition the robot into and out of “stairs mode”) on the operator of the robot is both inconvenient for the operator and potentially dangerous for the robot should the operator neglect to make such a transition. For instance, the robot could tumble down the stairs and become damaged or otherwise cause harm in various ways if not transitioned into “stairs mode” prior to attempting to traverse stairs. To facilitate manual toggling into and out of “stairs mode” some previous systems included at least one additional, readily accessible user interface (UI) element on the controller for the robot, thus adding complexity and clutter to the user interface.

Some embodiments of the present disclosure provide a robot configured to automatically transition into and out of “stairs mode” as the robot is traveling along a path through an environment. As noted above, in some prior implementations, transitioning a robot into a “stairs mode” included configuring the robot, e.g., by adjusting one or more settings, to both (A) facilitate the perception of stairs, and (B) enable the robot to successfully traverse stairs. In accordance with some embodiments of the present disclosure, a robot may be configured to employ some or all of the “stair perception” functionality for identifying stairs on at least certain occasions when it is not also employing the “stair traversal” functionality. As explained in more detail below, in some implementations, by continuously employing at least certain aspects of the “stair perception” functionality, a robot may reliably detect stairs as it is moving about its environment and may be able to accurately predict when it needs to also implement the “stair traversal” functionality to enable the robot to successfully traverse stairs.

In some implementations, a robot may be configured to detect the presence or absence of stairs in the environment of the robot using sensor data that is acquired while the robot is traveling along a path. For example, a robot may be configured such that, should an operator use a joystick or the like to steer the robot in the direction of stairs, the robot may, as the robot is approaching the stairs, acquire and use sensor data to identify the existence of the stairs and then automatically switch the robot to “stairs mode” if the robot determines that its planned path will intersect the identified stairs. Further, as explained in more detail below, a similar technique may be employed to identify regions including other features (e.g., ice patches, steep hills, loose gravel, etc.) within an environment, and then automatically transition the robot to a specialized operational mode to enable effective and safe traversal over or through such regions, e.g., when the robot determines that its planned path will intersect a region in which such a feature is located.

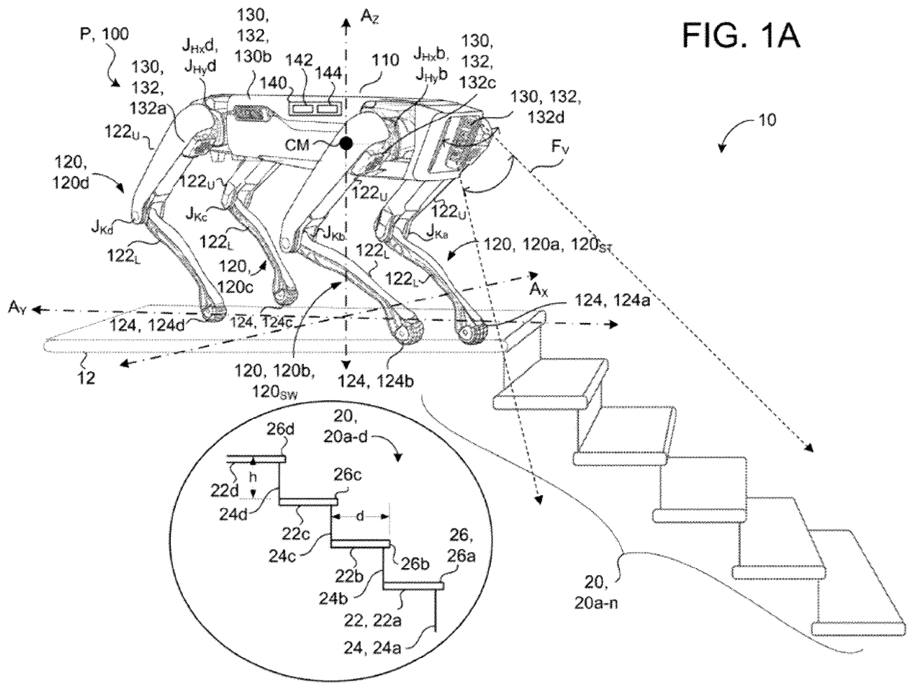

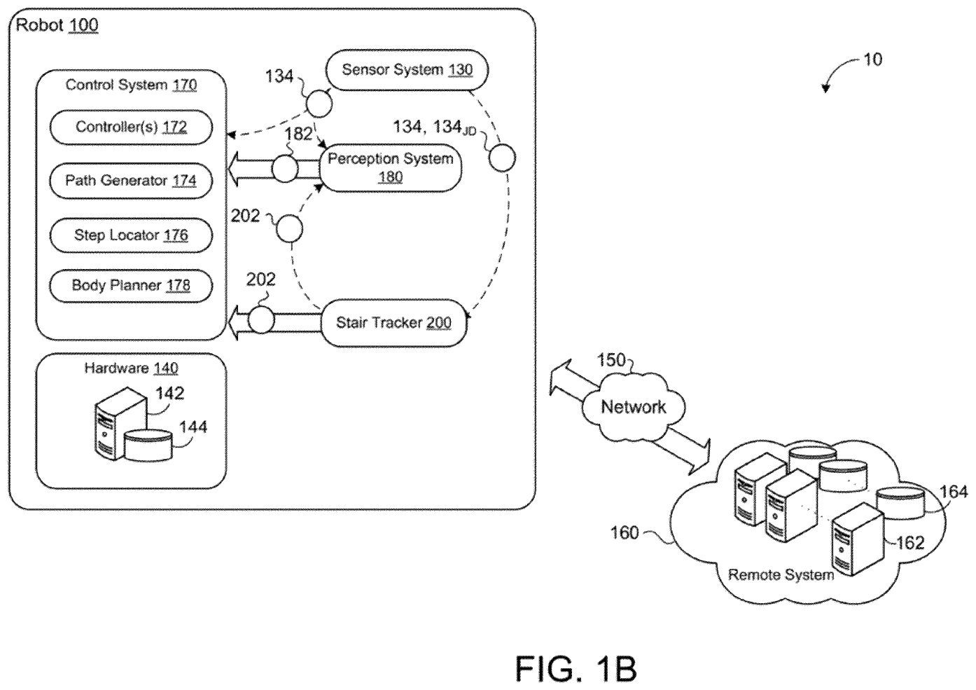

FIG. 1A shows an example of an environment 10 for a robot 100. The environment 10 generally refers to a spatial area associated with some type of terrain. As illustrated in FIG. 1A, such terrain may include stairs 20, 20a-n or stair-like terrain that may be traversed by the robot 100 (e.g., using a control system 170 as shown in FIG. 1B). One or more systems of the robot 100 may be responsible for coordinating and/or moving the robot 100 about the environment 10. As the robot 100 moves about the environment 10, such system(s) may analyze the terrain, plan motion trajectories for the robot 100 (e.g., with a path generator 174, a step planner 176, a body planner 178), and/or instruct the robot 100 to perform various movements (e.g., with one or more controllers 172). In some implementations, the robot 100 may use various systems of the robot 100 to attempt to successfully traverse the environment 10 while avoiding collisions and/or damage to the robot 100 or the environment 10.

Stairs 20, 20a-n generally refer to a group of more than one stair 20 (i.e., a group of “n” stairs 20) designed to bridge a vertical distance. To bridge the vertical distance, stairs 20a-n typically run a horizontal distance with a given rise in vertical height over a pitch (or pitch line). Each stair 20 may include a tread 22 and a riser 24. The tread 22 of a stair 20 refers to a horizontal part of the stair 20 that is stepped on while a riser 24 refers to a vertical portion of the stair 20 between each tread 22. The tread 22 of each stair 20 spans a tread depth “d” measuring from an outer edge 26 of a stair 20 to the riser 24 between stairs 20. For a residential, a commercial, or an industrial structure, some stairs 20 also include a nosing as part of the edge 26 for safety purposes. A nosing, as shown in FIG. 1A, is a part of the tread 22 that protrudes over a riser 24 beneath the tread 22. For example, the nosing (shown as edge 26a) is part of the tread 22a and protrudes over the riser 24a.

A set of stairs 20 may be preceded by or include a platform or support surface 12 (e.g., a level support surface). For example, a “landing” refers to a level platform or support surface 12 at the top of a set of stairs 20 or at a location between stairs 20. For instance, a landing occurs where a direction of the stairs 20 changes or between a particular number of stairs 20 (e.g., a flight of stairs 20 that connects two floors). FIG. 1A illustrates the robot 100 standing on a landing at the top of a set of stairs 20. Furthermore, a set of stairs 20 may be constrained between one or more walls and/or railings. In some examples, a wall may include a toe board (e.g., baseboard-like structure or runner at ends of the treads 22) or a stringer. In the case of industrial stairs 20 that are not completely enclosed, the stairs 20 may include a stringer that functions as a toe board (e.g., a metal stringer).

Stair-like terrain more generally refers to terrain that varies in height over some distance. Stair-like terrain may resemble stairs in terms of a change in elevation (e.g., an inclined pitch with a gain in elevation or a declined pitch with a loss in elevation). However, with stair-like terrain the delineation of treads 22 and risers 24 is not as obvious. Rather, stair-like terrain may refer to terrain with tread-like portions that allow a robot to have enough traction to plant a stance limb and sequentially or simultaneously use a leading limb to ascend or to descend over an adjacent vertical obstruction (resembling a riser) within the terrain. For example, stair-like terrain my include rubble, an inclined rock scramble, damaged or deteriorating traditional stairs, etc.

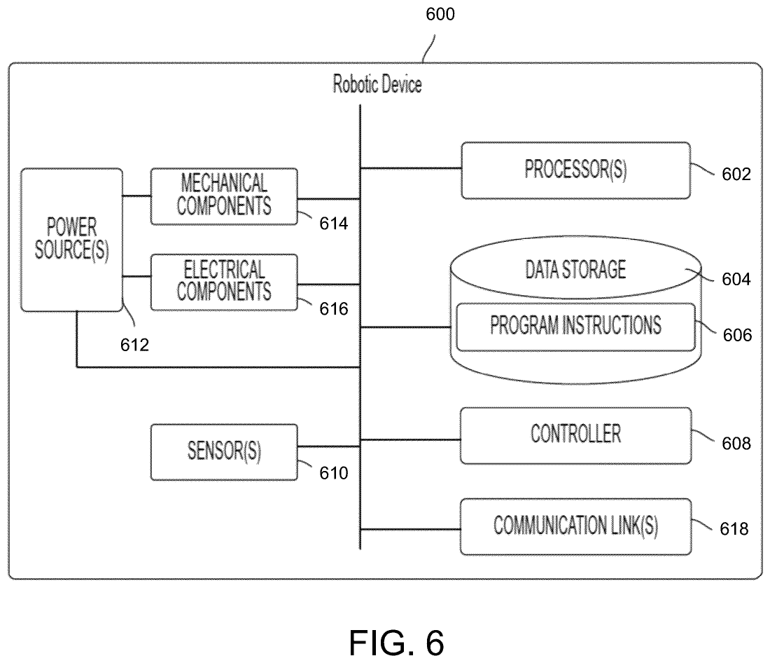

Referring to FIG. 1A, the robot 100 may include a body 110 with locomotion based structures such as legs 120a-d coupled to the body 110 that enable the robot 100 to move about the environment 10. An illustrative system diagram that may represent some operational components of the robot 100 is also described below in relation to FIG. 6. As illustrated in FIG. 1A, in some implementations, each leg 120 may be an articulable structure such that one or more joints J permit members 122 of the leg 120 to move. For instance, each leg 120 may include a hip joint J_{H} coupling an upper member 122, 122u of the leg 120 to the body 110, and a knee joint J_{K} coupling the upper member 122u of the leg 120 to a lower member 122_{L} of the leg 120. For impact detection, the hip joint J_{H} may be further broken down into abduction-adduction rotation of the hip joint J_{H} (designated as “J_{Hx}”) for occurring in a frontal plane of the robot 100 (i.e., an X-Z plane extending in directions of the x-direction axis Aₓ and the z-direction axis A_{Z}) and a flexion-extension rotation of the hip joint J_{H} (designated as “J_{Hy}”) for occurring in a sagittal plane of the robot 100 (i.e., a Y-Z plane extending in directions of the y-direction axis A_{Y} and the z-direction axis A_{Z}). Although FIG. 1A depicts a quadruped robot with four legs 120a-d, it should be appreciated that the robot 100 may include any number of legs or locomotive based structures (e.g., a biped or humanoid robot with two legs) that provide a means to traverse the terrain within the environment 10.

In order to traverse the terrain, each leg 120 may have a distal end 124 that contacts a surface 12 of the terrain (i.e., a traction surface). In other words, the distal end 124 of the leg 120 is the end of the leg 120 used by the robot 100 to pivot, plant, or generally provide traction during movement of the robot 100. For example, the distal end 124 of a leg 120 may correspond to a “foot” of the robot 100. In some examples, though not shown, the distal end 124 of the leg 120 may include an ankle joint J_{A} such that the distal end 124 is articulable with respect to the lower member 122_{L} of the leg 120.

The robot 100 may have a vertical gravitational axis (e.g., shown as a Z-direction axis A_{Z}) along a direction of gravity, and a center of mass CM, which is a point where the weighted relative position of the distributed mass of the robot 100 sums to zero. The robot 100 may further have a pose P based on the CM relative to the vertical gravitational axis A_{Z} (i.e., the fixed reference frame with respect to gravity) to define a particular attitude or stance assumed by the robot 100. The attitude of the robot 100 can be defined by an orientation or an angular position of the robot 100 in space. Movement by the legs 120 relative to the body 110 alters the pose P of the robot 100 (i.e., the combination of the position of the CM of the robot and the attitude or orientation of the robot 100). Here, a height (i.e., vertical distance) generally refers to a distance along (e.g., parallel to) the z-direction (i.e., z-axis A_{Z}). The sagittal plane of the robot 100 corresponds to the Y-Z plane extending in directions of the y-direction axis A_{Y} and the z-direction axis A_{Z}. In other words, the sagittal plane bisects the robot 100 into a left and right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a support surface 12 where distal ends 124 of the legs 120 of the robot 100 may generate traction to help the robot 100 move about the environment 10. Another anatomical plane of the robot 100 is the frontal plane that extends across the body 110 of the robot 100 (e.g., from a left side of the robot 100 with a first leg 120a to a right side of the robot 100 with a second leg 120b). The frontal plane spans the X-Z plane by extending in directions of the x-direction axis Ax and the z-direction axis A_{Z}.

When a legged robot moves about the environment 10, the legs 120 of the robot may undergo a gait cycle. Generally, a gait cycle begins when a leg 120 touches down or contacts a support surface 12 and ends when that same leg 120 once again contacts the support surface 12. The touching down of a leg 120 may also be referred to as a “footfall” defining a point or position where the distal end 124 of a locomotion-based structure 120 falls into contact with the support surface 12. The gait cycle may predominantly be divided into two phases, a swing phase and a stance phase. During the swing phase, a leg 120 performs (i) lift-off from the support surface 12 (also sometimes referred to as toe-off and the transition between the stance phase and swing phase), (ii) flexion at a knee joint J_{K} of the leg 120, (iii) extension of the knee joint J_{K} of the leg 120, and (iv) touchdown (or footfall) back to the support surface 12. Here, a leg 120 in the swing phase is referred to as a swing leg 120_{SW}. As the swing leg 120_{SW} proceeds through the movement of the swing phase 120_{SW}, another leg 120 performs the stance phase. The stance phase refers to a period of time where a distal end 124 (e.g., a foot) of the leg 120 is on the support surface 12. During the stance phase, a leg 120 performs (i) initial support surface contact which triggers a transition from the swing phase to the stance phase, (ii) loading response where the leg 120 dampens support surface contact, (iii) mid-stance support for when the contralateral leg (i.e., the swing leg 120_{SW}) lifts-off and swings to a balanced position (about halfway through the swing phase), and (iv) terminal-stance support from when the robot's CM is over the leg 120 until the contralateral leg 120 touches down to the support surface 12. Here, a leg 120 in the stance phase is referred to as a stance leg 120_{ST}.

To enable the robot to perceive the environment 10, the robot 100 may include a sensor system 130 with one or more sensors 132, 132a-n. The sensors 132 may include vision/image sensors, inertial sensors (e.g., an inertial measurement unit (IMU)), force sensors, and/or kinematic sensors. Some examples of sensors 132 include a camera such as a stereo camera, a scanning light-detection and ranging (LIDAR) sensor, or a scanning laser-detection and ranging (LADAR) sensor. In some implementations, the robot 100 may include two stereo cameras as sensors 132 at a front end of the body 110 of the robot 100 (i.e., a “head” of the robot 100 adjacent the front legs 120a-b of the robot 100) and one stereo camera as a sensor 132 at a back end of the body 110 of the robot 100 adjacent rear legs 120c-d of the robot 100. In some implementations, the respective sensors 132 may have corresponding fields of view Fᵥ, defining a sensing range or region corresponding to the sensor 132. For instance, FIG. 1A depicts a field of a view Fᵥ for the robot 100. Each sensor 132 may be pivotable and/or rotatable such that the sensor 132 may change the field of view Fᵥ about one or more axis (e.g., an x-axis, a y-axis, or a z-axis in relation to a ground plane).

Referring to FIGS. 1A and 1B, in some implementations, the sensor system 130 may include sensor(s) 132 coupled to a joint J. In some implementations, these sensors 132 may be coupled to a motor that operates a joint J of the robot 100 (e.g., sensors 132, 132a-b). Here, these sensors 132 may generate joint dynamics 134, 134_{JD} in the form of joint-based sensor data 134. Joint dynamics 134_{JD} collected as joint-based sensor data 134 may include joint angles (e.g., an upper member 122u relative to a lower member 122_{L}), joint speed (e.g., joint angular velocity or joint angular acceleration), and/or joint torques experienced at a joint J (also referred to as joint forces). Here, joint-based sensor data 134 generated by one or more sensors 132 may be raw sensor data, data that is further processed to form different types of joint dynamics 134_{JD}, or some combination of both. For instance, a sensor 132 may measure joint position (or a position of member(s) 122 coupled at a joint J) and systems of the robot 100 may perform further processing to derive velocity and/or acceleration from the positional data. In other examples, one or more sensors 132 may be configured to measure velocity and/or acceleration directly.

When surveying a field of view Fᵥ with a sensor 132, the sensor system 130 may generate sensor data 134 (also referred to herein as image data) corresponding to the field of view Fᵥ. In some implementations, the sensor data 134 may be image data that corresponds to a three-dimensional volumetric point cloud generated by a three-dimensional volumetric image sensor 132. Additionally or alternatively, when the robot 100 is maneuvering about the environment 10, the sensor system 130 may gather pose data for the robot 100 that includes inertial measurement data (e.g., measured by an IMU). In some implementations, such pose data may include kinematic data and/or orientation data about the robot 100, for instance, kinematic data and/or orientation data about joints J or other portions of a leg 120 of the robot 100. With the sensor data 134, a perception system 180 of the robot 100 may generate perception maps 182 for the terrain about the environment 10.

While the robot 100 maneuvers about the environment 10, the sensor system 130 may gather sensor data 134 relating to the terrain of the environment 10 and/or structure of the robot 100 (e.g., joint dynamics and/or odometry of the robot 100). For instance, FIG. 1A depicts the robot 100 standing on a landing (i.e., level support surface) of a set of stairs 20 in the environment 10 of the robot 100. Here, the sensor system 130 may be gathering sensor data 134 about the set of stairs 20. As the sensor system 130 gathers sensor data 134, a computing system 140 may store, process, and/or communicate the sensor data 134 to various systems of the robot 100 (e.g., the control system 170, the perception system 180, and/or a stair tracker 200). In order to perform computing tasks related to the sensor data 134, the computing system 140 of the robot 100 may include data processing hardware 142 and memory hardware 144. The data processing hardware 142 may be configured to execute instructions stored in the memory hardware 144 to perform computing tasks related to activities (e.g., movement and/or movement-based activities) for the robot 100. Generally speaking, the computing system 140 refers to one or more instances of data processing hardware 142 and/or memory hardware 144.

With continued reference to FIGS. 1A and 1B, in some implementations, the computing system 140 may be a local system located on the robot 100. When located on the robot 100, the computing system 140 may be centralized (i.e., in a single location/area on the robot 100, for example, the body 110 of the robot 100), decentralized (i.e., located at various locations about the robot 100), or a hybrid combination of both (e.g., with a majority of the hardware being centralized and a minority of the hardware being decentralized). A decentralized computing system 140 may, for example, allow processing to occur at an activity location (e.g., at a motor that moves a joint of a leg 120) while a centralized computing system 140 may, for example, allow for a central processing hub that communicates to systems located at various positions on the robot 100 (e.g., communicate to the motor that moves the joint of the leg 120).

Additionally or alternatively, the computing system 140 may employ and/or interact with computing resources that are located remotely from the robot 100. For instance, the computing system 140 may communicate via a network 150 with a remote system 160 (e.g., a remote computer/server or a cloud-based environment). Much like the computing system 140, the remote system 160 may include remote computing resources such as remote data processing hardware 162 and remote memory hardware 164. Here, sensor data 134 or other processed data (e.g., data processing locally by the computing system 140) may be stored in the remote system 160 and may be accessible to the computing system 140. In some implementations, the computing system 140 may be configured to utilize the remote resources 162, 164 as extensions of the computing resources 142, 144 such that resources of the computing system 140 may reside on resources of the remote system 160.

In some implementations, as shown in FIGS. 1A and 1B, the robot 100 may include a control system 170 and a perception system 180. The perception system 180 may be configured to receive the sensor data 134 from the sensor system 130 and process the sensor data 134 to generate one or more perception maps 182. The perception system 180 may communicate such perception map(s) 182 to the control system 170 in order to perform controlled actions for the robot 100, such as moving the robot 100 about the environment 10. In some implementations, by having the perception system 180 separate from, yet in communication with the control system 170, processing for the control system 170 may focus on controlling the robot 100 while the processing for the perception system 180 may focus on interpreting the sensor data 134 gathered by the sensor system 130. For instance, these systems 170, 180 may execute their processing in parallel to ensure accurate, fluid movement of the robot 100 in an environment 10.

In some implementations, the control system 170 may include at least one controller 172, a path generator 174, a step locator 176, and a body planner 178. The control system 170 may be configured to communicate with at least one sensor system 130 and any other system of the robot 100 (e.g., the perception system 180 and/or the stair tracker 200). The control system 170 may perform operations and other functions using hardware 140. The controller(s) 172 may be configured to control movement of the robot 100 to traverse about the environment 10 based on input or feedback from the systems of the robot 100 (e.g., the control system 170, the perception system 180 and/or the stair tracker 200). This may include movement between poses and/or behaviors of the robot 100. For example, the controller(s) 172 may control different footstep patterns, leg patterns, body movement patterns, or vision system sensing patterns.

In some implementations, the controller(s) 172 may include a plurality of controllers 172, where each of the controllers 172 may be configured to operate the robot 100 at a fixed cadence. A fixed cadence refers to a fixed timing for a step or swing phase of a leg 120. For example, an individual controller 172 may instruct the robot 100 to move the legs 120 (e.g., take a step) at a particular frequency (e.g., step every 250 milliseconds, 350 milliseconds, etc.). With a plurality of controllers 172, where each controller 172 is configured to operate the robot 100 at a fixed cadence, the robot 100 can experience variable timing by switching between the different controllers 172. In some implementations, the robot 100 may continuously switch/select fixed cadence controllers 172 (e.g., re-select a controller 170 every three milliseconds) as the robot 100 traverses the environment 10.

In some implementations, the control system 170 may additionally or alternatively include specialty controllers 172 that are dedicated to a particular control purpose. For example, the control system 170 may include one or more stair controllers 172 dedicated to planning and coordinating the robot's movement to traverse a set of stairs 20. For instance, a stair controller 172 may ensure the footpath for a swing leg 120_{SW} maintains a swing height to clear a riser 24 and/or edge 26 of a stair 20. Other specialty controllers 172 may include the path generator 174, the step locator 176, and/or the body planner 178.

Referring to FIG. 1B, the path generator 174 may be configured to determine horizontal motion for the robot 100. As used herein, the term “horizontal motion” refers to translation (i.e., movement in the X-Y plane) and/or yaw (i.e., rotation about the Z-direction axis A_{z}) of the robot 100. The path generator 174 may determine obstacles within the environment 10 about the robot 100 based on the sensor data 134. The path generator 174 may determine the planned path of the body 110 of the robot for some future period (e.g., for the next 1-1.5 seconds). Such determination of the planned path of the body 110 by the path generator 174 may occur much more frequently, however, such as hundreds of times per second. In this manner, in some implementations, the path generator 174 may determine a new planned path for the body 110 every few milliseconds, with each new trajectory being planned for a period of 1-1.5 or so seconds into the future.

The path generator 174 may communicate information concerning the currently planned path, as well as identified obstacles, to the step locator 176 such that the step locator 176 may identify foot placements for legs 120 of the robot 100 (e.g., locations to place the distal ends 124 of the legs 120 of the robot 100). The step locator 176 may generate the foot placements (i.e., locations where the robot 100 should step) using inputs from the perception system 180 (e.g., perception map(s) 182). The body planner 178, much like the step locator 176, may receive inputs from the perception system 180 (e.g., perception map(s) 182). Generally speaking, the body planner 178 may be configured to adjust dynamics of the body 110 of the robot 100 (e.g., rotation, such as pitch or yaw and/or height of CM) to successfully move about the environment 10.

The perception system 180 may enable the robot 100 to move more precisely in a terrain with various obstacles. As the sensors 132 collect sensor data 134 for the space about the robot 100 (i.e., the robot's environment 10), the perception system 180 may use the sensor data 134 to form one or more perception maps 182 for the environment 10. In some implementations, the perception system 180 may also be configured to modify an existing perception map 182 (e.g., by projecting sensor data 134 on a preexisting map) and/or to remove information from a perception map 182.

In some implementations, the one or more perception maps 182 generated by the perception system 180 may include a ground height map, a no step map, and a body obstacle map. The ground height map refers to a map 182 generated by the perception system 180 based on voxels from a voxel map. In some implementations, the ground height map may function such that, at each X-Y location within a grid of the map 182 (e.g., designated as a cell of the ground height map), the ground height map specifies a height. In other words, the ground height map may convey that, at a particular X-Y location in a horizontal plane, the robot 100 should step at a certain height.

The no step map generally refers to a map 182 that defines regions where the robot 100 is not allowed to step in order to advise the robot 100 when the robot 100 may step at a particular horizontal location (i.e., location in the X-Y plane). In some implementations, much like the ground height map, the no step map may be partitioned into a grid of cells in which each cell represents a particular area in the environment 10 of the robot 100. For instance, each cell may correspond to a three centimeter square within an X-Y plane within the environment 10. When the perception system 180 generates the no step map, the perception system 180 may generate a Boolean value map where the Boolean value map identifies “no step” regions and “step” regions. A no step region refers to a region of one or more cells where an obstacle exists while a step region refers to a region of one or more cells where an obstacle is not perceived to exist. The perception system 180 may further process the Boolean value map such that the no step map includes a signed-distance field. Here, the signed-distance field for the no step map may include a distance to a boundary of an obstacle (e.g., a distance to a boundary of the no step region) and a vector “v” (e.g., defining nearest direction to the boundary of the no step region) to the boundary of an obstacle.

The body obstacle map generally determines whether the body 110 of the robot 100 overlaps a location in the X-Y plane with respect to the robot 100. In other words, the body obstacle map may identify obstacles for the robot 100 to indicate whether the robot 100, by overlapping at a location in the environment 10, risks collision or potential damage with obstacles near or at the same location. As a map of obstacles for the body 110 of the robot 100, systems of the robot 100 (e.g., the control system 170) may use the body obstacle map to identify boundaries adjacent, or nearest to, the robot 100 as well as to identify directions (e.g., an optimal direction) to move the robot 100 in order to avoid an obstacle. In some implementations, much like other maps 182, the perception system 182 may generate the body obstacle map according to a grid of cells (e.g., a grid of cells in the X-Y plane). Here, each cell within the body obstacle map may include a distance from an obstacle and a vector pointing to the closest cell that is identified as a portion of an obstacle (i.e., a boundary of the obstacle).

Situations may arise where certain types of structures within the environment 10 may routinely result in poor sensor data 134. The robot 100 may, however, still attempt to navigate and/or to perform tasks within the environment 10 even when poor sensor data 134 exists. One type of structure that often leads to poor sensor data 134 is stairs 20. This is particularly problematic because stairs 20 are a fairly common structural feature in commercial and residential environments. Furthermore, poor sensor data 134 for stair navigation may be problematic because stairs also generally demand precise leg movement and foot placement for successful traversal. Since stairs may be a difficult feature to navigate from a coordination perspective, poor sensor data 134 may significantly compound the navigational challenges of the robot.

A sensor 132 may produce poor sensor data 134 for a variety of reasons. With regard to stairs 20, two separate problems may commonly occur. One problem generally pertains to stair ascent while the other problem pertains to stair descent. For stair ascent, open riser stairs 20 may pose issues for the robot 100. With open riser stairs 20, the sensor(s) 132 of the robot 100 may be at a sensing height equal to a height of one or more stairs 20. At this height, the sensor 132 may generate far sensor data 134 through the open riser 24 and near sensor data 134 for an edge 26 of a stair 20. In other words, when the sensor 132 cannot see the riser 24 on open riser stairs, the edge 26 of the treads 22 of the stairs 20 may appear to the robot 100 as floating rungs and may be falsely identified as obstacles of the robot 100 by the robot's perception system 180 rather than stairs. When a robot 100 is about to descend, or is in the act of descending a set of stairs 20, a sensor 132, such as a stereo camera, may produce poor sensor data 134 due to the repetitive structure and lines that define a typical staircase. For example, stereo cameras specifically function by trying to find a portion of two different images that are the same object in the real world and use parallax to determine a distance for that object. Yet, based on the repeating lines of a staircase when viewing it from top to bottom, sensors 132 are more likely to mismatch the same object and thus generate poor sensor data 134. This is particularly common for industrial or grated staircases because the grating introduces more repeating lines that the sensor 132 is more apt to mismatch. Although not all staircases are grated, this presents a problem to the navigation of the robot 100 because robots 100 may often be deployed in industrial environments 10. Though these scenarios do not occur for every type of staircase, a robot 100 that struggles to ascend one type of staircase and to descend another may limit the robot's versatility and robustness to successfully traverse an environment.

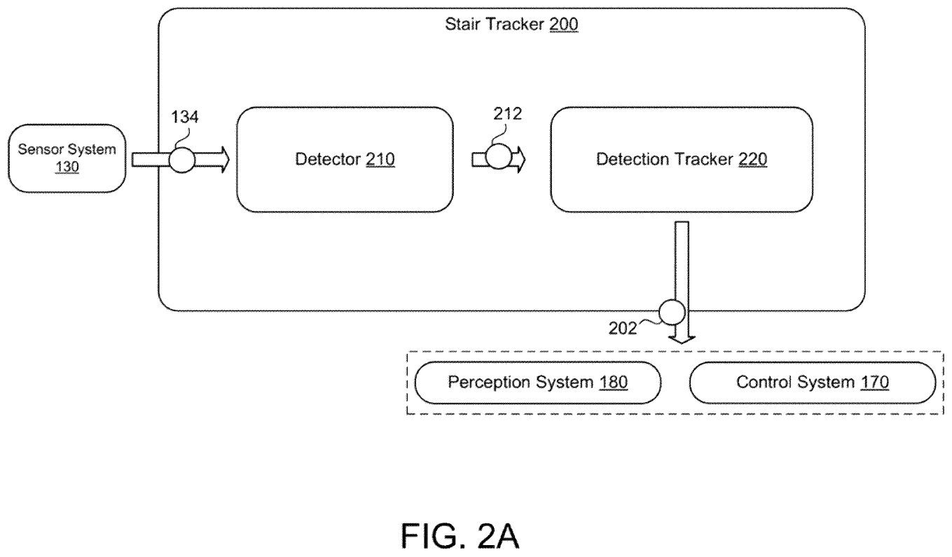

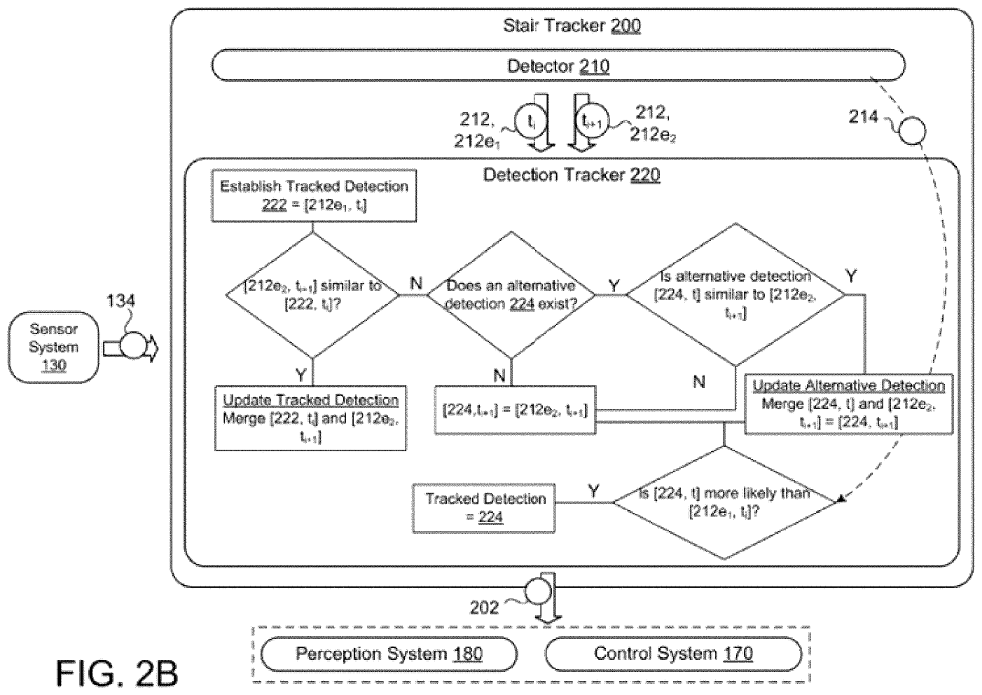

To attempt to address some of these sensor data issues, as illustrated in FIG. 1B, the robot 100 may use a system called a stair tracker 200 for detecting and tracking features for stairs 20. The stair tracker 200 may allow the robot 100 to understand ambiguous data. Referring to FIGS. 2A and 2B, in some implementations, the stair tracker 200 may be configured to receive sensor data 134 and output a stair model 202. Such a stair model 202 may represent some form of a floor height and a series of stairs 20. In some implementations, the stair model 202 may represent a configuration of a staircase and/or a location of the staircase relative to the robot 100. Here, a stair 20 is a line segment with a direction, a location, and an extent in either direction. The stair tracker 200 may generally assume the stairs 20 are horizontally constrained and include a minimum/maximum rise and a minimum/maximum run. Alternatively, the slope may be constrained to a minimum/maximum value.

As shown in FIG. 2A, in some implementations, to generate a stair model 202, the stair tracker 200 may include a detector 210 and a detection tracker 220. The detector 210 of the stair tracker 200 may receive the sensor data 134 from the sensor system 130 and generate one or more detected features 212. Such detected features 212 may correspond to different structural features of the stairs 20, such as edges 26, treads 22, risers 24, walls 28, and/or some combination thereof. As the robot 100 approaches a set of stairs 20, the detector 210 may function to determine a detected feature 212 (e.g., shown in FIG. 2B as a detected edge 212, 212e) corresponding to a feature of the stairs 20 (e.g., an edge 26 of a first stair 20). The detector 210 may generate the detected feature 212 at a particular time tᵢ. Once the detector 210 determines the detected feature 212 at the particular time tᵢ, the detection tracker 220 may monitor whether this detected feature 212e remains the best representation of the actual feature for the stairs 20 during future time steps. In other words, the stair tracker 200 may receive sensor data 134 (e.g., at a particular frequency) as the sensor system 130 captures the sensor data 134. The detector 210 may determine the detected feature 212 at a first time step t₁ based on both sensor data 134 from the first time step t₁ and aggregate sensor data 134 from prior time steps tᵢ₋₁. The detector 210 may communicate the detected feature 212 to the detection tracker 220 and the detection tracker 220 may establish the detected feature 212 as a tracked detection 222 (also referred to as a primary detection) or initial detection when no primary detection exists at the detection tracker 220. In other words, when the detection tracker 220 is not tracking the stair feature corresponding to the detected feature 212 received from the detector 210, the detection tracker 212 may initialize a tracking process for this stair feature using the detected feature 212 at the first time step t₁. For instance, FIG. 2B illustrates the detection tracker 220 identifying the first detected feature 212, 212e₁ for an edge 26 of a stair 20 at the first time step t₁ as the tracked detection 222. At a second time step t₂ subsequent to the first time step t₁, the stair tracker 200 receives sensor data 134 generated at the second time step t₂ and/or during a time period between the first time step t₁ and the second time step t₂ as the most recent sensor data 134. Using the most recent sensor data 134, the detector 210 generates another detected feature 212 at a later time tᵢ₋₁. For example, the detector 210 generates a second detected feature 212, 212e₂ for the edge 26 of the stair 20 at the second time step t₂.

To perform its tracking process, when the detection tracker 220 receives the second detected feature 212, 212₂, the detection tracker 220 may determine whether the second detected feature 212₂ received at the second time step t₂ is similar to the first detected feature 212₁ from the first time step t₁ (now the tracked detection 222). When the first and the second detected features 212 are similar, the detection tracker 220 may merge the first and the second detected features 212 together to update the tracked detection 222. Here, during a merging operation, the detection tracker 220 may merge detected features 212 together with the tracked detection 222 using averaging (e.g., a weighted average weighted by a confidence error in the detected feature 212). When the second detected feature 212₂ is not similar to the first detected feature 212₁ the detection tracker 220 may determine whether an alternative tracked feature 224 exists for the stair feature corresponding to the second detected feature 212₂ (i.e., has the detection tracker 220 previously identified at detected feature 212 as an alternative tracked feature 224). When an alternative tracked feature 224 does not exist, the detection tracker 220 may establish the second detected feature 212₂ at the second time step t₂ to be the alternative tracked feature 224. When an alternative tracked feature 224 already exists, the detection tracker 220 may determine whether the second detected feature 212₂ at the second time step t₂ is similar to the existing alternative tracked feature 224. When the second detected feature 212₂ at the second time step t₂ is similar to the existing alternative tracked feature 224, the detection tracker 220 may merge the second detected feature 212₂ at the second time step t₂ with the existing alternative tracked feature 224 (e.g., using averaging or weighted averaging). When the second detected feature 212₂ at the second time step t₂ is not similar to the existing alternative tracked feature 224, the detection tracker 200 may generate another alternative tracked feature 224 equal to the second detected feature 212₂ at the second time step t₂. In some examples, the detection tracker 220 may be configured to track and/or store multiple alternative detections 224.

By using the tracking process of the detection tracker 220 in conjunction with the detector 210, the stair tracker 200 may vet each detection to prevent the stair tracker 200 from detrimentally relying on a detection. In other words, with the robot 100 constantly gathering sensor data 134 about its environment (e.g., at a frequency of 15 Hz), a reliance on a single detection from a snapshot of sensor data 134 may cause inaccuracy as to the actual location of features of the stairs 20. For example, a robot 100 may move or change its pose P between a first time and a second time generating sensor data 134 for areas of the stairs 20 that were previously occluded, partially occluded, or poorly captured in general. Here, a system that only performed a single detection at the first time may suffer from incomplete sensor data 134 and inaccurately detect a feature. In contrast, by constantly tracking each detection based on the most recent sensor data 134 available to the stair tracker 200 over a period of time, the stair tracker 200 may generate a bimodal probability distribution for a detected stair feature (e.g., a primary detection and an alternative detection). With a bimodal probability distribution for a feature of a stair 20, the stair tracker 200 is able to generate an accurate representation for the feature of the stair 20 to include in the stair model 202. Furthermore, this detection and tracking process tolerates a detection at any particular instance in time that corresponds to arbitrary poor sensor data 134 because that detection is tracked and averaged over time with other detections (e.g., presumably detections based on better data or based on a greater aggregate of data over multiple detections). Therefore, although a single detection may appear noisy at any moment in time, the merging and alternative swapping operations of the detection tracker 220 develop an accurate representation of stair features over time.

These stair features may then be incorporated into the stair model 202 that the stair tracker 200 generates and communicates to various systems of the robot 100 (e.g., systems that control the robot 100 to traverse the stairs 20). In some configurations, the stair tracker 200 may incorporate a tracked feature 222 into the stair model 202 once the tracked feature 222 has been detected by the detector 210 and tracked by the detection tracker 220 for some number of iterations. For example, when the detection tracker 220 has tracked the same feature for three to five detection/tracking cycles, the stair tracker 200 may incorporate the tracked detection 222 (i.e., a detection that has been updated for multiple detection cycles) for this feature into the stair model 202. Stated differently, the stair detector 200 may determine that the tracked detection 222 has matured over the detection and tracking process into a most likely candidate for a feature for the stairs 20.

When a sensor 132 peers down a set of stairs 20, this descending vantage point for a sensor 132 produces a different quality of sensor data 134 than a sensor 132 peering up a set of stairs 20. For example, peering up a set of stairs 20 has a vantage point occluding the treads 22 of stairs 20 and some of the riser 24 while peering down the set of stairs 20 has a vantage point that occludes the risers 24 and a portion of the treads 22. Due to these differences, among other reasons, the stair tracker 200 may have separate functionality dedicated to stair ascent (e.g., a stair ascent tracker) and stair descent (e.g., a stair descent tracker). For example, each type of stair tracker may be part of the stair tracker 200, but may be implemented as separate software modules. In some configurations, each type stair tracker, though implemented via separate modules, may coordinate with each other. For instance, the stair ascent tracker may pass information to the stair descent tracker (or vice versa) when the robot 100 changes directions during stair navigation (e.g., on the stairs 20).

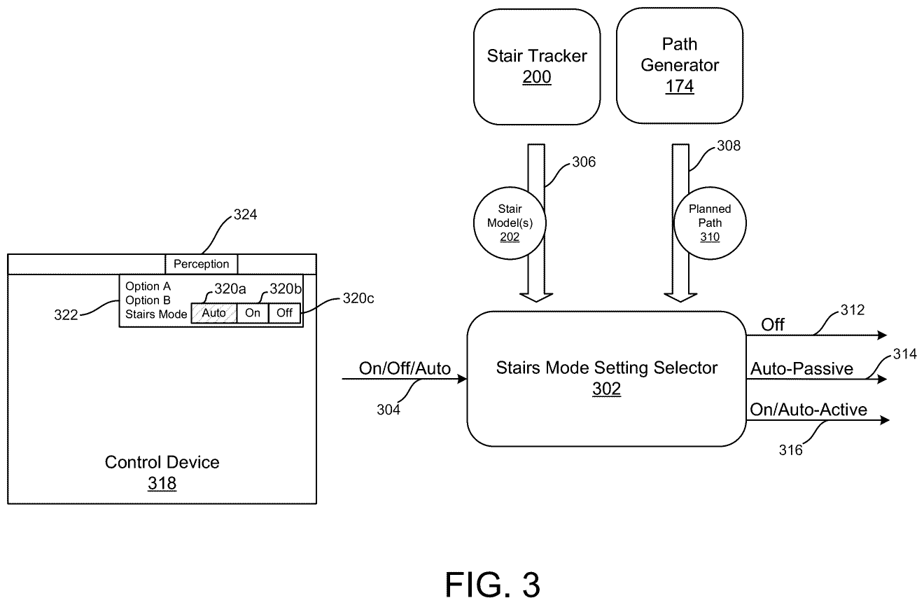

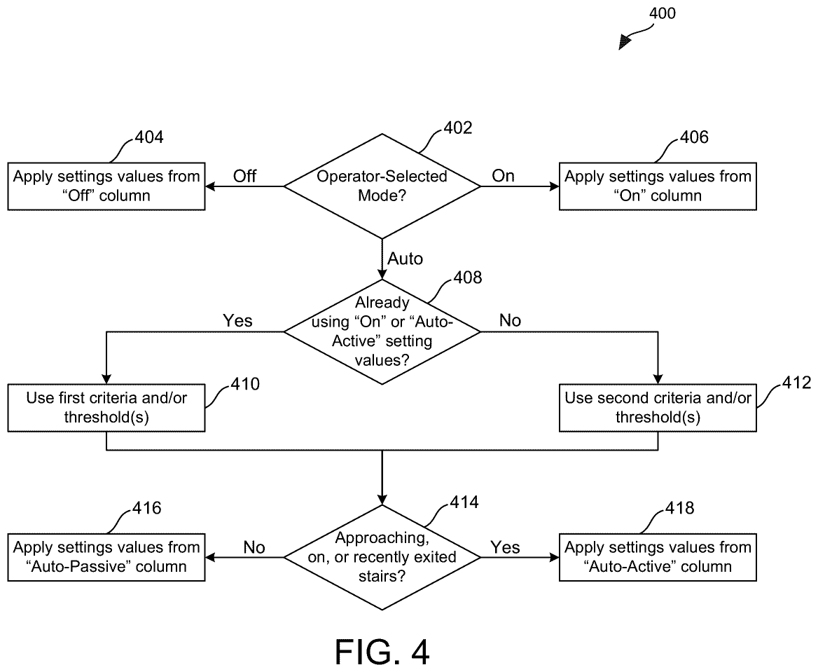

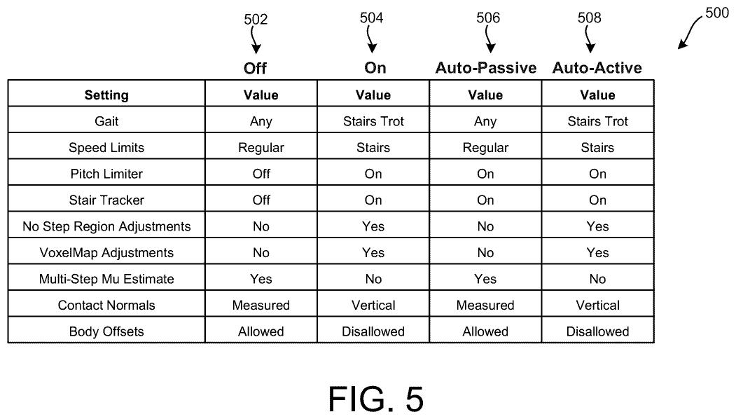

FIG. 3 shows an additional module (i.e., a stairs mode setting selector 302) that may be included in a robot 100 (e.g., as a part of the control system 170 shown in FIG. 1B or otherwise) to enable automatic transition of the robot to a “stairs mode” in accordance with some embodiments of the present disclosure. FIG. 4 shows an example decision tree 400 that may be employed by the stairs mode setting selector 302 shown in FIG. 3. FIG. 5 is a table 500 showing values of settings for the robot 100 that may be adjusted during execution of the decision tree 400 (shown in FIG. 4) by the stairs mode setting selector 302 (shown in FIG. 3) in accordance with some embodiments. As shown in FIG. 5, the table 500 may include columns 502, 504, 506, and 508 corresponding to respective groups of setting values that may be selected by the stairs mode setting selector 302. The manner in which the setting values shown in the columns 502, 504, 506, and 508 of the table 500 can be used to control various aspects of the robot 100 to facilitate the automatic identification and traversal of stairs 20 is described in detail below.

As indicated by an arrow 304 in FIG. 3, in some implementations, the stairs mode setting selector 302 may receive an input (e.g., based on a user's selection of a UI control) indicating selection of one of multiple (e.g., three) possible modes of operation of the stairs mode setting selector 302, e.g., “on,” “off,” or “auto.” As shown, in some implementations, a control device 318, such a tablet or other mobile device that can be operated to control or otherwise provide inputs to the robot 100, may include UI elements 320a, 320b, 320c that can be selected by a user to indicate a desired mode of operation for the stairs mode setting selector 302. As illustrated, in some implementations, the UI elements 320a, 320b, 320c may be accessed, along with other control options relating to the perception system 180, from a drop down menu 322 that be viewed in response to selection of a “perception” tab 324 or the like from a menu presented by the control device 318. Although not shown in FIG. 3, it should be appreciated that the control device 318 may further be configured with additional UI elements to enable a user to steer or otherwise direct operation of the robot 100.

Further, as indicated by arrows 306 and 308 in FIG. 3, in some implementations, the stairs mode setting selector 302 may receive both (A) first data indicating that stairs 20 have been detected within an environment 10 of the robot 100, and (B) second data indicating a planned path 310 for the robot 100. In the illustrated example, the first data includes one or more stair models 202 determined by the stair tracker 202, and the second data includes an indication of the planned path 310 of the body 110 of the robot 100, as determined by the path generator 174. Based on the selected mode, e.g., “on,” “off,” or “auto,” the stairs mode setting selector 302 may apply appropriate setting values (described in detail below) as indicated, for example, in the columns 502, 504, 506, and 508 of the table 500 (shown in FIG. 5). For instance, some or all of the setting values in the column 502 may be applied when the “off” mode is selected; some or all of the setting values in the column 504 may be applied when the “on” mode is selected; and some or all of the settings values in a selected one of the columns 506 and 508 may be applied when the “auto” mode is selected. The column 506, 508 that is used at a given time may be determined, for example, based on the received first data (e.g., the stair model(s) 202) and the received second data (e.g., the planned path 310).

In some embodiments, the stairs mode setting selector 302 may be configured to output setting values (indicated by arrows 312, 314, and 316 in FIG. 3) based on the inputs received by the stair mode setting selector 302. In particular, the “off” setting values (per the column 502) are indicated by the arrow 312, the “auto-passive” setting values (per the column 506) are indicated by the arrow 314, and the “on” setting values (per the column 504), as well as the “auto-active” setting values (per the column 508), are indicated by the arrow 316. Because the “on” setting values (per the column 504) and the “auto-active” setting values (per the column 508) are identical in the illustrated example, in some implementations, a single column may be used to represent the setting values for both such circumstances.

As noted previously, some prior systems provided an operator with the ability to manually toggle the “stairs mode” between an “on” state and an “off” state (e.g., to switch between the setting values of the columns 502 and 504) before and after the user directed the robot to traverse a staircase. The columns 506 and 508 show the same settings as the columns 502 and 504, but illustrate how the values of those settings can change dynamically when the robot 100 is operating in an automatic stairs mode (referred to herein as “auto” or “auto stairs” mode) in accordance with the present disclosure. In particular, the column 506 illustrates setting values for a scenario in which the robot 100 is operating in the “auto stairs” mode but has not yet determined that traversal of stairs 20 is imminent (referred to herein as “auto-passive” state), whereas the column 508 illustrates setting values for a scenario in which the robot 100 is likewise operating in the “auto stairs” mode but has, in fact, determined that traversal of stairs 20 is imminent (referred to herein as “auto-active” state). As explained below, in some implementations, the stairs mode setting selector 302 may additionally apply “auto-active” settings (per the column 508), rather than the “auto-passive” settings (per the column 506), when it determines that the robot 100 recently exited a staircase (e.g., in case it is on a landing between staircases), and/or that the robot 100 is currently on stairs 20 (e.g., in case something precluded the stair tracker 200 from identifying stairs 20).

As can be seen by comparing the columns 508 and 504, the various settings may have the same values when the robot 100 is operating in the “auto-active” state (per the column 508) as when the robot 100 is operating with the “stairs mode” turned “on” (per the column 504). On the other hand, as can be seen by comparing columns 502 and 506, when the robot 100 is operating in the “auto-passive” state (per the column 506), the values for only two of the illustrated settings (i.e., “pitch limiter” and “stair tracker”) are different than when the robot is operating with the “stairs mode” turned “off” (per the column 502). Additionally, as can be seen by comparing the columns 506 and 504, when the robot 100 is operating in the “auto-passive” state (per the column 506), the values for only two of the illustrated settings (i.e., “pitch limiter” and “stair tracker”) are the same as when the robot 100 is operating with the “stairs mode” turned “on” (per the column 504).

As explained in more detail below, when the robot 100 is operating in the “auto-passive” state (per the column 506), the indicated values of the “pitch limiter” and “stair tracker” settings (i.e., “pitch limiter=on” and “stair tracker=on”) may enable the robot 100 to identify stairs 20 within the environment 10, thus enabling the stairs mode setting selector 302 to determine whether traversal of the identified stairs by the robot 100 is imminent in view of the planned path 310 provided by the path generator 174. The values of the remaining settings may not be changed, so as to allow the robot 100 to continue moving around the environment 10 without taking any extra actions to enable traversal of stairs 20. In some implementations, only after the robot 100 has determined, while in the “auto-passive” state (per the column 506), that the traversal of stairs 20 within the environment 10 is imminent will the values of the remaining settings be switched to those shown in the column 508, thus enabling the robot 100 to take particular actions to ensure that the identified stairs 20 can be safely traversed. Advantageously, the operator of the robot 100 need not manually switch the robot 100 from one mode to another before and after traversing stairs 20. Instead, when the robot 100 is operating in the “auto stairs” mode, as disclosed herein, the operator may simply steer the robot 100 about the environment 10, and the robot 100 will itself automatically determine whether and when to enable its robust stair traversal capabilities.

As noted previously, the decision tree 400 shown in FIG. 4 may be executed by the stairs mode setting selector 302 (shown in FIG. 3) in accordance with some embodiments of the present disclosure. As described in detail below, based on various inputs received by the stairs mode setting selector 302, the stairs mode setting selector 302 may use the decision tree 400 to select one of the columns 502, 504, 506, 506 of the table 500 for use in determining certain setting values for the robot 100. In particular, when the stairs mode setting selector 302 reaches a node 404 of the decision tree 400, it may apply the settings from the “off” column 502; when the stairs mode setting selector 302 reaches a node 406 of the decision tree 400, it may apply the settings from the “on” column 504; when the stairs mode setting selector 302 reaches a node 416 of the decision tree 400, it may apply the settings from the “auto-passive” column 506; and when the stairs mode setting selector 302 reaches a node 418 of the decision tree 400, it may apply the settings from the “auto-active” column 508. Further, as described in detail below, in some implementations, the evaluation performed at a decision 414 may use either first criteria and/or threshold(s) (per a block 410) or second criteria and/or threshold(s) (per a block 412), depending on the outcome of a preceding decision 408. As explained below, the use of such different criteria and/or threshold(s) for making the decision 414 may introduce hysteresis into the setting value selection process, thus preventing undesirable rapid switching between the “auto-active” and “auto-passive” states. In some implementations, the sequence of decisions 402, 408 and 414 may be performed several hundred times per second, thus ensuring that transitions from the “auto-passive” state to the “auto-active” state, and vice versa, occur quickly enough to ensure the robot 100 is in an optimal state at all times.

As shown in FIG. 4, the decision tree 400 may include an initial decision 402, at which the stairs mode setting selector 302 may determine which of several operational modes has been selected (e.g., per the arrow 304 in FIG. 3) by an operator. For example, as described above, for example, an operator of the robot 100 may select one of the UI elements 320a-c on the control device 318 (e.g., a physical switch/button on a hand-held controller, a “soft” switch/button on a tablet, etc.) to select one of “on,” “off” or “auto” as the operational mode for the stairs mode setting selector 302.

As shown, when the “off” operational mode has been selected (e.g., in response to the operator selecting the UI element 320c on the control device 318), the stairs mode setting selector 302 may apply the settings from the “off” column 502 of the table 500 (shown in FIG. 5). As noted previously, the application of these setting values may correspond to the arrow 312 shown in FIG. 3. Similarly, when the “on” operational mode has been selected (e.g., in response to the operator selecting the UI element 320b on the control device 318), the stairs mode setting selector 302 may apply the settings from the “on” column 504 of the table 500 (shown in FIG. 5). As noted previously, the application of these setting values may correspond to the arrow 316 shown in FIG. 3. When the “auto” mode has been selected (e.g., in response to the operator selecting the UI element 320a on the control device 318), however, the stairs mode selector 302 may proceed to the decision 408 of the decision tree 400.

As shown in FIG. 4, at the decision 408, the stairs mode setting selector 302 may determine whether the robot 100 is already using either the “on” setting values (per the column 504 of the table 500) or the “auto-active” setting values (per the column 508 of the table 500). When the stairs mode setting selector 302 determines that the robot 100 is already using either the “on” setting values or the “auto-active” setting values, it may proceed to make the decision 414 (described in detail below) using the first criteria and/or threshold(s) (per the block 410). When, on the other hand, the stairs mode setting selector 302 determines that the robot 100 is not already using either the “on” setting values or the “auto-active” setting values, it may instead proceed to make the decision 414 using the second criteria and/or threshold(s) (per the block 412).

As indicated in FIG. 4, at the decision 414, the stairs mode setting selector 302 may determine, using either the first criteria and/or threshold(s) (per the block 410) or the second criteria and/or threshold(s) (per the block 412), whether robot 100 is approaching, is currently on, or has recently exited stairs 20.

As shown, when the stairs mode setting selector 302 determines (per the decision 414) that the robot 100 is not approaching stairs, is not currently on stairs, and has not recently exited stairs, the stairs mode setting selector 302 may proceed to the node 416 at which it may apply the setting values from the “auto-passive” column 506 of the table 500 (shown in FIG. 5). As noted previously, the application of those setting values may correspond to the arrow 314 shown in FIG. 3. Further, as noted above, when the “auto-passive” setting values (per the column 506) are applied, certain of those settings values (e.g., “pitch limiter”=“on” and “stair tracker”=“on”) may configure the robot 100 to actively “look” for stairs, while some or all of the remaining setting values need not be set to configure the robot 100 to proficiently traverse stairs.

When, on the other hand, the stairs mode setting selector 302 determines (per the decision 414) that the robot 100 is approaching stairs, is currently on stairs, or has recently exited stairs, the stairs mode setting selector 302 may instead proceed to the node 418 at which it may apply the setting values from the “auto-active” column 508 of the table 500 (shown in FIG. 5). As noted previously, the application of those setting values may correspond to the arrow 316 shown in FIG. 3. Further, as noted above, when the “auto-active” setting values (per the column 508) are applied, the robot 100 may be configured to both accurately perceive and proficiently traverse stairs 20.

In some implementations, the first criteria and/or threshold(s) (per the block 410) and the second criteria and/or threshold(s) (per the block 412) may differ in one or more significant respects. For example, the respective criteria and/or threshold(s) may be set so as to introduce hysteresis into the process that prevents undesirable rapid switching between the “auto-active” and “auto-passive” states. Examples of threshold(s) and/or criteria that may be set in this manner will now be described.

As noted above, in some implementations, a stair model 202 generated by the stair tracker 200 may represent both a configuration of a staircase and a location of the staircase relative to the robot 100. Further, as also described above, in some implementations, the path generator 174 may determine a planned path 310 of the robot for some future period (e.g., for the next 1-1.5 seconds), with adjustments to the planned path 310 by the path generator 174 occurring rapidly, such as hundreds of times per second.

In some implementations, when the decision 414 uses the second criteria and/or threshold(s) applied per the block 412, the stairs mode setting selector 302 may determine whether the planned path 310 for the subsequent 1-1.5 seconds, if followed, would intersect the location of stairs 20 indicated by the stair model 202. Upon the stairs mode setting selector 302 determining (per the decision 414) that such a condition is satisfied, the stairs mode setting selector 302 may, per the node 418, apply the “auto-active” setting values from the column 508 of the table 500 (shown in FIG. 5) to control operation of the robot 100. As illustrated in the column 508, and as also described in more detail below, the value of at least one of those settings (e.g., “speed limits”) may impact the speed of the robot 100, such as by causing the robot 100 to slow down to traverse stairs. Adjusting the speed of the robot 100 in such manner, however, may cause a corresponding change to the planned path 310. Such a change may result in the planned path 310 for the subsequent 1-1.5 seconds no longer intersecting the location of the stairs 20 due to the slowing of the robot 100. For this reason, after the stairs mode setting selector 302 has applied the “auto-active” setting values (per the block 418), the stairs mode setting selector 302 may immediately begin using the first criteria and/or threshold(s) (per the block 410) when making the decision 414. As shown in FIG. 4, such switching of the criteria and/or threshold(s) used to make the decision 414 may occur when the stairs mode setting selector 302 determines, at the decision 408, that the robot 100 is using the “auto-active” settings.

In some implementations, the first criteria and/or threshold(s) (per the block 410) may account for the reduced speed of the robot 100 after the “auto-active” setting values have been applied, such as by causing the stairs mode setting selector 302 to determine, e.g., at the decision 414, whether the planned path 310 for the subsequent 1-1.5 seconds, if followed, would result in the robot 100 moving along essentially the same planned path 304 that the stairs mode setting selector 302 previously determined (e.g., when the decision 414 used the second criteria and/or threshold(s) per the block 412) would intersect the stairs 20, albeit a lesser distance along that path. To achieve such a result, the first criteria and/or threshold(s) may, for example, include a condition that forces a positive (i.e., “yes”) outcome at the decision 414 if the stairs mode setting selector 302 determines that the planned path 310 for the subsequent 1-1.5 seconds, if followed, would result in the robot 100 moving along essentially the same planned path 304 that the stairs mode setting selector 302 previously determined would intersect the stairs 20. To make such a determination, the stairs mode setting selector 302 may, for example, determine whether the two planned paths are within a threshold degree of similarity.

In other implementations, a similar result may be obtained by using different time periods for determining the planned paths 304 that are evaluated at the decision 414 when the first criteria and/or threshold(s) and the second criteria and/or threshold(s) are used to make the decision 414. For example, in some implementations, use of the second criteria and/or threshold(s) (per the block 412) may cause the stairs mode setting selector 302 to determine, e.g., at the decision 414, whether the planned path 310 for the subsequent 500 milliseconds, if followed, would intersect the location of stairs 20 indicated by the stair model 202, whereas use of the first criteria and/or threshold(s) (per the block 412) may cause the stairs mode setting selector 302 to determine, e.g., at the decision 414, whether the planned path 310 for the subsequent 1-1.5 seconds, if followed, would intersect the location of stairs 20 indicated by the stair model 202.

In some implementations, the first criteria and/or threshold(s) used per the block 410 and/or second criteria and/or threshold(s) used per the block 412 may depend on the current state of the robot 100 and may be updated dynamically as the robot 100 is operating. For instance, in some implementations, the stairs mode setting selector 302 may set the first criteria and/or threshold(s) and/or the second criteria and/or threshold(s) based on the current speed and/or gait of the robot 100. As an example, if the robot 100 is currently operating in the “auto-passive” state (per the column 506 of the table 500 shown in FIG. 5), the stairs mode setting selector 302 may adjust the duration of the future time period for which it will determine (at the decision 414) whether the planned path 310 will intersect stairs (e.g., from 1.5 seconds to 750 milliseconds) in accordance with the current speed and/or gait of the robot 100. Making such speed-based and/or gait-based adjustments to the second criteria and/or threshold(s) may, for example, help ensure that the robot 100 has adequate time to decelerate, after transitioning from the “auto-passive” state to the “auto-active” state, prior to encountering the identified stairs 20.

As another example of different criteria and/or threshold(s) that may be used pursuant to the blocks 410 and 412, it may be desirable to refrain from transitioning from the “auto-active” state to the “auto-passive” state during the brief periods when the robot 100 is on a landing between different sections of a staircase. Accordingly, in some implementations, the first criteria and/or threshold(s) used pursuant to the block 410 may regulate the circumstances in which the robot 100 will transition from the “auto-active” state to the “auto-passive” state. For instance, in some implementations, the first criteria and/or threshold(s) used pursuant to the block 410 may allow a negative (i.e., “no”) outcome at the decision 414 only if the robot 100 has traveled more than 1 meter (e.g., a typical dimension of a landing between staircases) with the planned path 310 for the subsequent 1-1.5 seconds not intersecting the location of stairs 20. Using a distance threshold, rather than a time threshold, to determine whether the robot 100 has recently exited stairs may be preferable, as it is common for operators to pause forward motion of the robot 100 after reaching a landing between staircases.

In some implementations, rapid switching between the “auto-active” and “auto-passive” states may additionally or alternatively be inhibited by configuring the first criteria and/or threshold(s) and/or the second criteria and/or threshold(s) to include a requirement that a threshold amount of time must elapse after switching from one state to the other (e.g., from the “auto-passive” state to the “auto-active” state), before allowing a transition back to the prior state (e.g., from the “auto-active” state to the “auto-passive” state).

Many other configurations of the first criteria and/or threshold(s) and/or the second criteria and/or threshold(s) to introduce hysteresis and/or other desired behavior into the operation of stairs mode setting selector 302 are likewise possible.

As noted above, in some implementations, the decision 414 may further involve determining whether the robot is currently on stairs 20. In some implementations, for example, the stair tracker 200 may be configured, based on sensor data 134 and/or kinematic data, to determine that the robot 100 is currently on stairs 20. When, at the decision 414, the stairs mode setting selector 302 determines that the robot 100 is currently on stairs (using the stair tracker 200 or otherwise), the stairs mode setting selector 302 may automatically place the robot 100 in the “auto-active” state (per the node 418 of the decision tree 400), even if the stairs mode setting selector 302 has not determined that the planned path 310 will intersect the location of stairs 20 indicated by a stair model 202. Taking this step may allow the robot 100 to successfully navigate stairs 20 in the event of a failure of the stair tracker 200 to accurately identify stairs 20 within the robot's planned path.

The purpose and function of the example settings listed in the table 500 (shown in FIG. 5) will now be described. It should be appreciated, however, that different, fewer, or additional settings may be employed in other embodiments or for other purposes, e.g., to enable the robot 100 to automatically enter an “ice patch” state, a “steep hill” state, a “loose gravel” state, or the like.

The value of the “gait” setting shown the table 500 may determine allowable values for the current gait for the robot 100. Examples of possible “gait” setting values include (1) “crawl,” in which the robot 100 picks up one leg 120 at a time as it moves, (2) “walk” (which may alternatively be referred to as “trot”) in which the robot 100 picks up one diagonal pair of legs 120 at a time, (3) “jog,” in which the robot 100 also picks up one diagonal pair of legs 120 at a time but at a faster cadence than in the “walk” mode and also including a flight phase during which all four legs 120 are in the air, (4) “stairs trot,” in which to robot picks up one diagonal pair of legs 120 at a time and in manner optimized for stair traversal, and (5) “hop,” in which the robot 100 takes five quick jumps with one diagonal pair of legs 120, followed by five quick jumps with the other diagonal pair of legs 120, and then repeats. As shown in the columns 504 and 508 of the table 500 (shown in FIG. 5), when “stairs mode” has been set to “on” (per the column 504) or the stairs mode setting selector 302 determines to transition the robot 100 to the “auto-active” mode (per the column 508), the value of the “gait” setting may be set to “stairs trot.” As shown in the columns 502 and 506 of the table 500 (shown in FIG. 5), when the “stairs mode” has been set to “off” (per the column 502) or the stairs mode setting selector 302 determines to transition the robot 100 to the “auto-passive” state (per the column 506), the “gait” setting may be allowed to take on any of the other possible values for gait noted above.

The “speed limits” setting may control the maximum speed at which the robot 100 is permitted to travel. When the value of the “speed limits” setting is set to “stairs” (e.g., per the columns 504 and 508 of the table 500 shown in FIG. 5), the maximum speed may be reduced to a level that ensures safe traversal of stairs 20. In some implementations, the speed limit for stair traversal may depend on one or more dimensions and/or other features of the stairs, e.g., as determined by the stair tracker 200. For example, the stair traversal speed limit may be reduced when narrow, steeper, and/or larger-stepped staircases are identified by the stair tracker 200.

The “pitch limiter” setting, when set to “on,” may control the pitch of the robot 100 when the robot is backing up, i.e., moving in reverse, and the stair tracker 200 is unable to determine (e.g., due to poor sensor data quality or otherwise) whether stairs 20 are present behind the robot 200, thus ensuring that the field of the view of the sensor 132 at the rear of the robot 100 points sufficiently downward to enable the robot 100 to accurately identify a downward going staircase 20. In particular, when the “pitch limiter” setting value is set to “on,” the robot 100 may be precluded from assuming a pose, while moving in reverse at a time that the stair tracker 200 is unable to determine whether stairs 20 are present, at which the pitch of the body 110 of the robot 100 causes the field of view of the rear sensor 132 to move upward by more than a threshold angle. When the “pitch limiter” setting is set to “off” (e.g., per the column 502 of the table 500 shown in FIG. 5), the pitch controls noted above are not employed.

The “stair tracker” setting may determine whether the stair tracker 200 (described above) is actively operating. As indicated in the columns 502, 504, 506, and 508 of the table 500 (shown in FIG. 5), the value of the “stair tracker” setting may be set to “on” unless the “stairs mode” has been set to “off” (per the column 502).

The “no step region adjustments” setting may determine whether special adjustments and/or filtering are to be made when identifying “no step regions” for the robot 100 while traversing stairs. As described above in connection with FIG. 1B, in some implementations, the perception system 180 may generate a “no step map” that defines regions where the robot 100 is not allowed to step in order to advise the robot 100 when the robot 100 may step at a particular horizontal location (i.e., location in the X-Y plane). In some implementations, the process for generating such “no step map” may be adjusted slightly to enable the robot 100 to successfully traverse stairs 20.

As shown in the columns 504 and 508 of the table 500 (shown in FIG. 5), when “stairs mode” has been set to “on” (per the column 504) or the stairs mode setting selector 302 determines to transition the robot 100 to the “auto-active” state (per the column 508), the value of the “no step regions adjustments” setting may be set to “yes.” As shown in the columns 502 and 506 of the table 500 (shown in FIG. 5), when the “stairs mode” has been set to “off” (per the column 502) or the stairs mode setting selector 302 determines to transition the robot 100 to the “auto-passive” state (per the column 506), the value of the “no step region adjustments” setting may instead be set to “no.”

The “voxel map adjustments” setting may determine whether special assumptions are to be made by the perception system 180, e.g., to account for bad or missing sensor data, when generating voxel maps while traversing stairs 20. For instance, due to the pitch of the body 110 of the robot 100 when traveling up a staircase, the field of view of the sensors 132 may not include portions of the top landing, or, for open riser stairs, problems can arise because the field of the view of the sensors 132 includes the bottom surface, rather than the top surface, of the top landing. In some implementations, when the value of the “voxel map adjustments” setting is “yes” (e.g., per the columns 504 and 508 of the table 500 shown in FIG. 5), for locations where sensor data is missing or ambiguous, the perception system 180 may generate voxel data by assuming that surfaces at unknown or occluded locations are flat (i.e., level with respect to the direction of gravity). On the other hand, when the value of the “voxel map adjustments” setting is “no” (e.g., per the columns 502 and 506 of the table 500 shown in FIG. 5), for locations where sensor data is missing or ambiguous, the perception system 180 may instead generate voxel data by assuming that surfaces at unknown or occluded locations will be consistent with the current ground plane perceived by the robot 100, which may or may not be level with respect to the direction of gravity.

The “multi-step mu estimate” setting may determine how the ground coefficient of friction (μ) is determined during movement of the robot 100. In some implementations, when the value of the “multi-step mu estimate” setting is “yes” (e.g., per the columns 502 and 506 of the table 500 shown in FIG. 5), when a μ estimate for a given footstep indicates the presence of relative slippery ground underneath the robot 100, the perception system 180 may assume that the robot 100 has encountered a slippery patch and may automatically use the same μ estimate for the next several steps of the robot 100. On the other hand, when the value of the “multi-step mu estimate” setting is “no” (e.g., per the columns 504 and 508 of the table 500 shown in FIG. 5), the perception system 180 may instead refrain from extending a μ estimate indicating a slippery surface underneath a given footstep to subsequent footsteps.

The “contact normals” setting may control how the direction normal to the surface underneath the robot 100, e.g., to inform force allocation decisions based on friction, is determined. In some implementations, when the value of the “contact normals” setting is “measured” (e.g., per the columns 502 and 506 of the table 500 shown in FIG. 5), the contact normal underneath the robot 100 may be extracted from the grid-based terrain determined by the perception system 180. On the other hand, when the value of the “contact normals” setting is “vertical” (e.g., per the columns 504 and 508 of the table 500 shown in FIG. 5), the perception system 180 may instead determine that all contact normals associated with a staircase that is being traversed are vertical with respect to the direction of gravity.

The “body offsets” setting may control whether the robot 100 may assume particular poses. In some implementations, when the value of the “body offsets” setting is “allowed” (e.g., per the columns 502 and 506 of the table 500 shown in FIG. 5), the robot 100 may be permitted to assume any of a variety of different poses, e.g., in response to operator commands input via the control device 318. On the other hand, when the value of the “body offsets” setting is “disallowed” (e.g., per the columns 504 and 508 of the table 500 shown in FIG. 5), the robot 100 may instead be forced to assume a particular pose while traversing stairs 20, with any user inputs to assume other poses being ignored.

FIG. 6 illustrates an example configuration of a robotic device (or “robot”) 600, according to some embodiments. The robotic device 600 may, for example, correspond to the robot 100 described above. The robotic device 600 represents an illustrative robotic device configured to perform any of the techniques described herein. The robotic device 600 may be configured to operate autonomously, semi-autonomously, and/or using directions provided by user(s), and may exist in various forms, such as a humanoid robot, biped, quadruped, or other mobile robot, among other examples. Furthermore, the robotic device 600 may also be referred to as a robotic system, mobile robot, or robot, among other designations.

As shown in FIG. 6, the robotic device 600 may include processor(s) 602, data storage 604, program instructions 606, controller 608, sensor(s) 610, power source(s) 612, mechanical components 614, and electrical components 616. The robotic device 600 is shown for illustration purposes and may include more or fewer components without departing from the scope of the disclosure herein. The various components of robotic device 600 may be connected in any manner, including via electronic communication means, e.g., wired or wireless connections. Further, in some examples, components of the robotic device 600 may be positioned on multiple distinct physical entities rather on a single physical entity.

The processor(s) 602 may operate as one or more general-purpose processor or special purpose processors (e.g., digital signal processors, application specific integrated circuits, etc.). The processor(s) 602 may, for example, correspond to the data processing hardware 142 of the robot 100 described above. The processor(s) 602 can be configured to execute computer-readable program instructions 606 that are stored in the data storage 604 and are executable to provide the operations of the robotic device 600 described herein. For instance, the program instructions 606 may be executable to provide operations of controller 608, where the controller 608 may be configured to cause activation and/or deactivation of the mechanical components 614 and the electrical components 616. The processor(s) 602 may operate and enable the robotic device 600 to perform various functions, including the functions described herein.

The data storage 604 may exist as various types of storage media, such as a memory. The data storage 604 may, for example, correspond to the memory hardware 144 of the robot 100 described above. The data storage 604 may include or take the form of one or more non-transitory computer-readable storage media that can be read or accessed by processor(s) 602. The one or more computer-readable storage media can include volatile and/or non-volatile storage components, such as optical, magnetic, organic or other memory or disc storage, which can be integrated in whole or in part with processor(s) 602. In some implementations, the data storage 604 can be implemented using a single physical device (e.g., one optical, magnetic, organic or other memory or disc storage unit), while in other implementations, the data storage 604 can be implemented using two or more physical devices, which may communicate electronically (e.g., via wired or wireless communication). Further, in addition to the computer-readable program instructions 606, the data storage 604 may include additional data such as diagnostic data, among other possibilities.

The robotic device 600 may include at least one controller 608, which may interface with the robotic device 600 and may be either integral with the robotic device, or separate from the robotic device 600. The controller 608 may serve as a link between portions of the robotic device 600, such as a link between mechanical components 614 and/or electrical components 616. In some instances, the controller 608 may serve as an interface between the robotic device 600 and another computing device. Furthermore, the controller 608 may serve as an interface between the robotic system 600 and a user(s). The controller 608 may include various components for communicating with the robotic device 600, including one or more joysticks or buttons, among other features. The controller 608 may perform other operations for the robotic device 600 as well. Other examples of controllers may exist as well.

Additionally, the robotic device 600 may include one or more sensor(s) 610 such as image sensors, force sensors, proximity sensors, motion sensors, load sensors, position sensors, touch sensors, depth sensors, ultrasonic range sensors, and/or infrared sensors, or combinations thereof, among other possibilities. The sensor(s) 610 may, for example, correspond to the sensors 132 of the robot 100 described above. The sensor(s) 610 may provide sensor data to the processor(s) 602 to allow for appropriate interaction of the robotic system 600 with the environment as well as monitoring of operation of the systems of the robotic device 600. The sensor data may be used in evaluation of various factors for activation and deactivation of mechanical components 614 and electrical components 616 by controller 608 and/or a computing system of the robotic device 600.

The sensor(s) 610 may provide information indicative of the environment of the robotic device for the controller 608 and/or computing system to use to determine operations for the robotic device 600. For example, the sensor(s) 610 may capture data corresponding to the terrain of the environment or location of nearby objects, which may assist with environment recognition and navigation, etc. In an example configuration, the robotic device 600 may include a sensor system that may include a camera, RADAR, LIDAR, time-of-flight camera, global positioning system (GPS) transceiver, and/or other sensors for capturing information of the environment of the robotic device 600. The sensor(s) 610 may monitor the environment in real-time and detect obstacles, elements of the terrain, weather conditions, temperature, and/or other parameters of the environment for the robotic device 600.

Further, the robotic device 600 may include other sensor(s) 610 configured to receive information indicative of the state of the robotic device 600, including sensor(s) 610 that may monitor the state of the various components of the robotic device 600. The sensor(s) 610 may measure activity of systems of the robotic device 600 and receive information based on the operation of the various features of the robotic device 600, such as the operation of extendable legs, arms, or other mechanical and/or electrical features of the robotic device 600. The sensor data provided by the sensors may enable the computing system of the robotic device 600 to determine errors in operation as well as monitor overall functioning of components of the robotic device 600.

For example, the computing system may use sensor data to determine the stability of the robotic device 600 during operations as well as measurements related to power levels, communication activities, components that require repair, among other information. As an example configuration, the robotic device 600 may include gyroscope(s), accelerometer(s), and/or other possible sensors to provide sensor data relating to the state of operation of the robotic device. Further, sensor(s) 610 may also monitor the current state of a function, such as a gait, that the robotic system 600 may currently be operating. Additionally, the sensor(s) 610 may measure a distance between a given robotic leg of a robotic device and a center of mass of the robotic device. Other example uses for the sensor(s) 610 may exist as well.

Additionally, the robotic device 600 may also include one or more power source(s) 612 configured to supply power to various components of the robotic device 600. Among possible power systems, the robotic device 600 may include a hydraulic system, electrical system, batteries, and/or other types of power systems. As an example illustration, the robotic device 600 may include one or more batteries configured to provide power to components via a wired and/or wireless connection. Within examples, components of the mechanical components 614 and electrical components 616 may each connect to a different power source or may be powered by the same power source. Components of the robotic system 600 may connect to multiple power sources as well.

Within example configurations, any suitable type of power source may be used to power the robotic device 600, such as a gasoline and/or electric engine. Further, the power source(s) 612 may charge using various types of charging, such as wired connections to an outside power source, wireless charging, combustion, or other examples. Other configurations may also be possible. Additionally, the robotic device 600 may include a hydraulic system configured to provide power to the mechanical components 614 using fluid power. Components of the robotic device 600 may operate based on hydraulic fluid being transmitted throughout the hydraulic system to various hydraulic motors and hydraulic cylinders, for example. The hydraulic system of the robotic device 600 may transfer a large amount of power through small tubes, flexible hoses, or other links between components of the robotic device 600. Other power sources may be included within the robotic device 600.

Mechanical components 614 can represent hardware of the robotic system 600 that may enable the robotic device 600 to operate and perform physical functions. As a few examples, the robotic device 600 may include actuator(s), extendable leg(s) (“legs”), arm(s), wheel(s), one or multiple structured bodies for housing the computing system or other components, and/or other mechanical components. The mechanical components 614 may depend on the design of the robotic device 600 and may also be based on the functions and/or tasks the robotic device 600 may be configured to perform. As such, depending on the operation and functions of the robotic device 600, different mechanical components 614 may be available for the robotic device 600 to utilize. In some examples, the robotic device 600 may be configured to add and/or remove mechanical components 614, which may involve assistance from a user and/or other robotic device. For example, the robotic device 600 may be initially configured with four legs, but may be altered by a user or the robotic device 600 to remove two of the four legs to operate as a biped. Other examples of mechanical components 614 may be included.

The electrical components 616 may include various components capable of processing, transferring, providing electrical charge or electric signals, for example. Among possible examples, the electrical components 616 may include electrical wires, circuitry, and/or wireless communication transmitters and receivers to enable operations of the robotic device 600. The electrical components 616 may interwork with the mechanical components 614 to enable the robotic device 600 to perform various operations. The electrical components 616 may be configured to provide power from the power source(s) 612 to the various mechanical components 614, for example. Further, the robotic device 600 may include electric motors. Other examples of electrical components 616 may exist as well.

In some implementations, the robotic device 600 may also include communication link(s) 618 configured to send and/or receive information. The communication link(s) 618 may transmit data indicating the state of the various components of the robotic device 600. For example, information read in by sensor(s) 610 may be transmitted via the communication link(s) 618 to a separate device. Other diagnostic information indicating the integrity or health of the power source(s) 612, mechanical components 614, electrical components 618, processor(s) 602, data storage 604, and/or controller 608 may be transmitted via the communication link(s) 618 to an external communication device.

In some implementations, the robotic device 600 may receive information at the communication link(s) 618 that is processed by the processor(s) 602. The received information may indicate data that is accessible by the processor(s) 602 during execution of the program instructions 606, for example. Further, the received information may change aspects of the controller 608 that may affect the behavior of the mechanical components 614 or the electrical components 616. In some cases, the received information indicates a query requesting a particular piece of information (e.g., the operational state of one or more of the components of the robotic device 600), and the processor(s) 602 may subsequently transmit that particular piece of information back out the communication link(s) 618.

In some cases, the communication link(s) 618 include a wired connection. The robotic device 600 may include one or more ports to interface the communication link(s) 618 to an external device. The communication link(s) 618 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-described functions. The one or more controllers can be implemented in numerous ways, such as with dedicated hardware or with one or more processors programmed using microcode or software to perform the functions recited above.

Various aspects of the present technology may be used alone, in combination, or in a variety of arrangements not specifically described in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, some embodiments may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments in detail, various modifications and improvements will readily occur to those skilled in the art. Such modifications and improvements are intended to be within the spirit and scope of the technology. Accordingly, the foregoing description is by way of example only, and is not intended as limiting.

What is claimed is:

1. A method, comprising:
receiving, by one or more sensors of a robot, data corresponding to one or more locations of the robot along a path the robot is following within an environment on a first occasion;
determining, based on the data, that one or more stairs exist in a first region of the environment;
determining, when the robot is at a position along the path the robot is following on the first occasion, that the robot is expected to enter the first region; and
controlling the robot to operate in a first operational mode associated with traversal of stairs when it is determined that one or more stairs exist in the first region and the robot is expected to enter the first region.

2. The method of claim 1, wherein determining that the robot is expected to enter the first region further comprises:
determining a planned path for the robot; and
determining that the planned path intersects the first region.

3. The method of claim 1, further comprising:
when the robot is operating in the first operational mode and is at a position along the path the robot is following on the first occasion, determining that the robot is not expected to enter any region of the environment that includes stairs; and
controlling the robot to operate in a second operational mode associated with traversal of terrain other than stairs when it is determined that the robot is not expected to enter any region of the environment that includes stairs.

4. The method of claim 3, further comprising:
controlling the robot to operate in the second operational mode prior to determining that the robot is expected to enter the first region; and
when the robot is operating in the second operational mode, using a first criterion and/or threshold to determine whether the robot is expected to enter the first region.

5. The method of claim 4, further comprising:
when the robot is operating in the first operational mode, using a second criterion and/or threshold, which is different than the first criterion and/or threshold, to determine, whether the robot is expected to enter any region of the environment that includes stairs.

6. The method of claim 3, wherein:
controlling the robot to operate in the first operational mode further comprises adjusting values of one or more settings to configure one or more systems of the robot to enable traversal of stairs, and
controlling the robot to operate in the second operational mode further comprises adjusting the values of the one or more settings to configure the one or more systems to enable traversal of terrain other than stairs.

7. The method of claim 3, wherein:
at least a first value of a first setting for the second operational mode enables the robot to identify stairs within the environment.

8. The method of claim 1, further comprising:
when the robot is at a position along the path the robot is following on the first occasion, determining that the robot is currently on stairs; and
controlling the robot to operate in the first operational mode when it is determined the robot is currently on stairs.

9. The method of claim 1, further comprising:
receiving a first command at a first time, corresponding to a first user input, instructing the robot to automatically transition between the first operational mode and a second operational mode associated with traversal of terrain other than stairs,
wherein the controlling the robot to operate in the first operational mode is based at least in part on receipt of the first command.

10. The method of claim 1, further comprising:
receiving a second command at a second time, corresponding to a second user input, instructing the robot to operate in the first operational mode; and
controlling the robot to operate in the first operational mode based on receipt of the second command.

11. The method of claim 1, further comprising:
receiving a third command at a third time, corresponding to a third user input, instructing the robot to operate in a second operational mode associated with traversal of terrain other than stairs; and
controlling the robot to operate in the second operational mode based on receipt of the third command.

12. The method of claim 1, wherein the path is determined prior to the robot traveling along the path.

13-48. (canceled)

49. A system, comprising:
at least one processor; and
at least one computer-readable medium encoded with instructions which, when executed by the at least one processor, cause the system to:
receive, by one or more sensors of a robot, data corresponding to one or more locations of the robot along a path the robot is following within an environment on a first occasion;
determine, based on the data, that one or more stairs exist in a first region of the environment;
determine, when the robot is at a position along the path the robot is following on the first occasion, that the robot is expected to enter the first region; and
control the robot to operate in a first operational mode associated with traversal of stairs when it is determined that one or more stairs exist in the first region and the robot is expected to enter the first region.

50. The system of claim 49, wherein the at least one computer-readable medium is further encoded with additional instructions which, when executed by the at least one processor, further cause the system to determine that the robot is expected to enter the first region at least in part by:
determining a planned path for the robot; and
determining that the planned path intersects the first region.

51. The system of claim 49, wherein the at least one computer-readable medium is further encoded with additional instructions which, when executed by the at least one processor, further cause the system to:
determine, when the robot is operating in the first operational mode and is at a position along the path the robot is following on the first occasion, that the robot is not expected to enter any region of the environment that includes stairs; and
control the robot to operate in a second operational mode associated with traversal of terrain other than stairs when it is determined that the robot is not expected to enter any region of the environment that includes stairs.

52. The system of claim 51, wherein the at least one computer-readable medium is further encoded with additional instructions which, when executed by the at least one processor, further cause the system to:
control the robot to operate in the second operational mode prior to determining that the robot is expected to enter the first region; and
when the robot is operating in the second operational mode, use a first criterion and/or threshold to determine whether the robot is expected to enter the first region.

53. The system of claim 52, wherein the at least one computer-readable medium is further encoded with additional instructions which, when executed by the at least one processor, further cause the system to:
when the robot is operating in the first operational mode, use a second criterion and/or threshold, which is different than the first criterion and/or threshold, to determine, whether the robot is expected to enter any region of the environment that includes stairs.

54. The system of claim 51, wherein the at least one computer-readable medium is further encoded with additional instructions which, when executed by the at least one processor, further cause the system to:
control the robot to operate in the first operational mode at least in part by adjusting values of one or more settings to configure one or more systems of the robot to enable traversal of stairs; and
control the robot to operate in the second operational mode at least in part by adjusting the values of the one or more settings to configure the one or more systems to enable traversal of terrain other than stairs.

55. The system of claim 51, wherein:
at least a first value of a first setting for the second operational mode enables the robot to identify stairs within the environment.

56. The system of claim 49, wherein the at least one computer-readable medium is further encoded with additional instructions which, when executed by the at least one processor, further cause the system to:
determine, when the robot is at a position along the path the robot is following on the first occasion, that the robot is currently on stairs; and
control the robot to operate in the first operational mode when it is determined the robot is currently on stairs.

57. The system of claim 49, wherein the at least one computer-readable medium is further encoded with additional instructions which, when executed by the at least one processor, further cause the system to:
receive a first command at a first time, corresponding to a first user input, instructing the robot to automatically transition between the first operational mode and a second operational mode associated with traversal of terrain other than stairs; and
control the robot to operate in the first operational mode based at least in part on receipt of the first command.

58. The system of claim 49, wherein the at least one computer-readable medium is further encoded with additional instructions which, when executed by the at least one processor, further cause the system to:
receive a second command at a second time, corresponding to a second user input, instructing the robot to operate in the first operational mode; and
control the robot to operate in the first operational mode based on receipt of the second command.

59. The system of claim 49, wherein the at least one computer-readable medium is further encoded with additional instructions which, when executed by the at least one processor, further cause the system to:
receive a third command at a third time, corresponding to a third user input, instructing the robot to operate in a second operational mode associated with traversal of terrain other than stairs; and
control the robot to operate in the second operational mode based on receipt of the third command.

60. The system of claim 49, wherein the path is determined prior to the robot traveling along the path.

61-143. (canceled)

144. A mobile robot, comprising:
a robot body;
one or more locomotion based structures, coupled to the body, the one or more locomotion based structures being configured to move the mobile robot about an environment;
one or more sensors, supported by the body, the one or more sensors being configured to output data concerning one or more sensed conditions of the environment;
at least one processor; and
at least one computer-readable medium encoded with instructions which, when executed by the at least one processor, cause the mobile robot to:
receive, by the one or more sensors, data corresponding to one or more locations of the mobile robot along a path the mobile robot is following within the environment on a first occasion;
determine, based on the data, that one or more stairs exist in a first region of the environment;
determine, when the mobile robot is at a position along the path the mobile robot is following on the first occasion, that the mobile robot is expected to enter the first region; and
control the mobile robot to operate in a first operational mode associated with traversal of stairs when it is determined that one or more stairs exist in the first region and the mobile robot is expected to enter the first region.

145. The mobile robot of claim 144, wherein the at least one computer readable medium is further encoded with additional instructions which, when executed by the at least one processor, further cause the mobile robot to determine that the mobile robot is expected to enter the first region at least in part by:
determining a planned path for the mobile robot; and
determining that the planned path intersects the first region.

146. The mobile robot of claim 144, wherein the at least one computer readable medium is further encoded with additional instructions which, when executed by the at least one processor, further cause the mobile robot to:
determine, when the mobile robot is operating in the first operational mode and is at a position along the path the mobile robot is following on the first occasion, that the mobile robot is not expected to enter any region of the environment that includes stairs; and
control the mobile robot to operate in a second operational mode associated with traversal of terrain other than stairs when it is determined that the mobile robot is not expected to enter any region of the environment that includes stairs.

147. The mobile robot of claim 146, wherein the at least one computer readable medium is further encoded with additional instructions which, when executed by the at least one processor, further cause the mobile robot to:
control the mobile robot to operate in the second operational mode prior to determining that the mobile robot is expected to enter the first region; and
when the mobile robot is operating in the second operational mode, use a first criterion and/or threshold to determine whether the mobile robot is expected to enter the first region.

148. The mobile robot of claim 147, wherein the at least one computer readable medium is further encoded with additional instructions which, when executed by the at least one processor, further cause the mobile robot to:
when the mobile robot is operating in the first operational mode, use a second criterion and/or threshold, which is different than the first criterion and/or threshold, to determine, whether the mobile robot is expected to enter any region of the environment that includes stairs.

149. The mobile robot of claim 146, wherein the at least one computer readable medium is further encoded with additional instructions which, when executed by the at least one processor, further cause the mobile robot to:
control the mobile robot to operate in the first operational mode at least in part by adjusting values of one or more settings to configure one or more systems of the mobile robot to enable traversal of stairs; and
control the mobile robot to operate in the second operational mode at least in part by adjusting the values of the one or more settings to configure the one or more systems to enable traversal of terrain other than stairs.

150. The mobile robot of claim 146, wherein:
at least a first value of a first setting for the second operational mode enables the mobile robot to identify stairs within the environment.

151. The mobile robot of claim 144, wherein the at least one computer readable medium is further encoded with additional instructions which, when executed by the at least one processor, further cause the mobile robot to:
determine, when the mobile robot is at a position along the path the mobile robot is following on the first occasion, that the mobile robot is currently on stairs; and
control the mobile robot to operate in the first operational mode when it is determined the mobile robot is currently on stairs.

152. The mobile robot of claim 144, wherein the at least one computer readable medium is further encoded with additional instructions which, when executed by the at least one processor, further cause the mobile robot to:
receive a first command at a first time, corresponding to a first user input, instructing the mobile robot to automatically transition between the first operational mode and a second operational mode associated with traversal of terrain other than stairs; and
control the mobile robot to operate in the first operational mode based at least in part on receipt of the first command.

153. The mobile robot of claim 144, wherein the at least one computer readable medium is further encoded with additional instructions which, when executed by the at least one processor, further cause the mobile robot to:
receive a second command at a second time, corresponding to a second user input, instructing the mobile robot to operate in the first operational mode; and
control the mobile robot to operate in the first operational mode based on receipt of the second command.

154. The mobile robot of claim 144, wherein the at least one computer readable medium is further encoded with additional instructions which, when executed by the at least one processor, further cause the mobile robot to:
receive a third command at a third time, corresponding to a third user input, instructing the mobile robot to operate in a second operational mode associated with traversal of terrain other than stairs; and
control the mobile robot to operate in the second operational mode based on receipt of the third command.

155. The mobile robot of claim 144, wherein the path is determined prior to the robot traveling along the path.

156-191. (canceled)
